(19) United States
(12) Patent Application Publication
(10) Pub. No.: US 2017/0228778 A1
(43) Pub. Date: Aug. 10, 2017

(54) INFORMATION PROCESSING DEVICE, INFORMATION PROCESSING METHOD, AND PROGRAM

(71) Applicant: SONY CORPORATION, TOKYO (JP)

(72) Inventors: YASUHARU ASANO, KANAGAWA (JP); SEIICHI TAKAMURA, TOKYO (JP); MASASHI SEKINO, TOKYO (JP); NORIYUKI YAMAMOTO, KANAGAWA (JP)

(73) Assignee: SONY CORPORATION, TOKYO (JP)

(21) Appl. No.: 15/519,128

(22) PCT Filed: Aug. 26, 2015
(86) PCT No.: PCT/JP2015/073986

§ 371 Date: Apr. 13, 2017

(30) Foreign Application Priority Data
Oct. 21, 2014 (JP) 2014-214369

(51) Int. Cl. G06Q 30/02; G06Q 50/00; G06F 17/30

(52) U.S. Cl. CPC G06Q 30/0255; G06F 17/30528; G06F 17/30554; G06Q 50/01; G06Q 30/0242

(57) ABSTRACT

To make it possible to further improve the convenience of a user. There is provided an information processing device including: a user characteristic identification unit configured to identify a characteristic of a user about content by relating user-sent information sent by the user for the content to the content; and a presentation information distribution unit configured to distribute presentation information to be presented to the user in relation to the content on the basis of characteristic information indicating the identified characteristic of the user.

### TECHNICAL FIELD

The present disclosure relates to an information processing device, an information processing method, and a program.

### BACKGROUND ART

Techniques have been generally developed that recommend various types of content (e.g., events such as concerts, plays, and movies) to users. For example, Patent Literature 1 discloses a technique of receiving position information from mobile communication terminals possessed by users, and distributing event information of an event to a mobile communication terminal that is positioned within a predetermined range of the venue of the event and has the acquisition date and time of the position information prior to the date and time of the event.

### CITATION LIST

### Patent Literature

Patent Literature 1: JP 2009-71499A

### DISCLOSURE OF INVENTION

### Technical Problem

It has been recently common for general users to send information via social media such as social networking services (SNSs). Examples of information sent by the users can include information that reflects preferences of the users for content like impressions about events in which the users participate. There is the possibility that the application of such information based on behaviors of users, for example, to the above-described content recommendation techniques make it possible to provide more convenient services to the users.

The present disclosure proposes a novel and improved information processing device, information processing method, and program that can improve the convenience of a user.

### Solution to Problem

According to the present disclosure, there is provided an information processing device including: a user characteristic identification unit configured to identify a characteristic of a user about content by relating user-sent information sent by the user for the content to the content; and a presentation information distribution unit configured to distribute presentation information to be presented to the user in relation to the content on the basis of characteristic information indicating the identified characteristic of the user.

Further, according to the present disclosure, there is provided an information processing method including, by a processor: identifying a characteristic of a user about content by relating user-sent information sent by the user for the content to the content; and distributing presentation information to be presented to the user in relation to the content on the basis of characteristic information indicating the identified characteristic of the user.

Further, according to the present disclosure, there is provided a program for a processor of a computer to execute: a function of identifying a characteristic of a user about content by relating user-sent information sent by the user for the content to the content; and a function of distributing presentation information to be presented to the user in relation to the content on the basis of characteristic information indicating the identified characteristic of the user.

According to the present disclosure, user-sent information is related to content, thereby more precisely distributing presentation information on the content to a user who has sent the user-sent information for the content (e.g., a user who has made a post such as an impression about the content). The user can thus obtain more necessary information for the user himself/herself, and the convenience of the user is improved.

### Advantageous Effects of Invention

As described above, according to the present disclosure, it is possible to improve the convenience of a user. Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrating a schematic configuration of a system according to an embodiment of the present disclosure.

FIG. 2 is a block diagram illustrating an example of a functional configuration of a client according to the present embodiment.

FIG. 3 is a block diagram illustrating an example of a functional configuration of a server according to the present embodiment.

FIG. 4 is a diagram illustrating an example of user-sent information stored in a user-sent information DB.

FIG. 5 is a diagram illustrating an example of event information stored in an event information DB.

FIG. 6 is a diagram illustrating an example of user preference information stored in a user preference information DB.

FIG. 7 is a diagram illustrating an example of variant spelling/relevance information stored in a variant spelling/relevance information DB.

FIG. 8 is a sequence diagram illustrating an example of a processing procedure of an information processing method according to the present embodiment.

FIG. 9 is a flowchart illustrating an example of a processing procedure in acquisition processing of user preference information.

FIG. 10 is a flowchart illustrating an example of a processing procedure in acquisition processing of user behavior attribute information.

FIG. 11 is a flowchart illustrating an example of a processing procedure of distribution processing of presentation information in a merchandise recommendation service.

FIG. 12 is a flowchart illustrating an example of a processing procedure of distribution processing of presentation information in a community forming service.

FIG. 13 is a diagram illustrating an example of a display screen provided to a user in the community forming service.

FIG. 14 is a diagram illustrating an example of video content information stored in a video content information DB.

FIG. 15 is a block diagram illustrating an example of a hardware configuration of an information processing device according to the present embodiment.

### MODE(S) FOR CARRYING OUT THE INVENTION

Hereinafter, (a) preferred embodiment(s) of the present disclosure will be described in detail with reference to the appended drawings. In this specification and the appended drawings, structural elements that have substantially the same function and structure are denoted with the same reference numerals, and repeated explanation of these structural elements is omitted.

The description will be now made in the following order.

### 1. Overview of System

### 2. Configuration of Client

### 3. Configuration of Server

### 4. Consideration of Processing of Relating User-sent Information to Event

### 5. Information Processing Method

### 5-1. Information Processing Method in System

### 5-2. Processing Procedure in Identification Processing of User Characteristic

### 5-2-1. Processing Procedure in Acquisition Processing of User Preference Information

### 5-2-2. Processing Procedure in Acquisition Processing of User Behavior Attribute Information

### 5-3. Processing Procedure in Distribution Processing of Presentation Information

### 5-3-1. Processing Procedure in Merchandise Recommendation Service

### 5-3-2. Processing Procedure in Community Forming Service

### 6. Modification

### 7. Hardware Configuration

### 8. Supplemental Information

### (1. Overview of System)

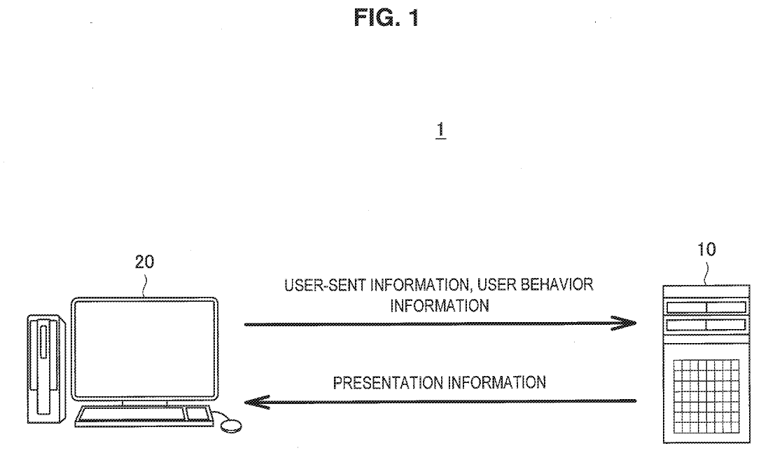

First, the overview of a system according to an embodiment of the present disclosure will be described with reference to FIG. 1. FIG. 1 is a diagram illustrating a schematic configuration of a system according an embodiment of the present disclosure.

FIG. 1 illustrates that a system 1 according to the present embodiment includes a server 10 and a client 20. The server 10 and the client 20 are connected to each other via a communication network (network) that is not illustrated in a manner that various types of information can be communicated.

The client 20 is an information processing device such as a personal computer (PC), a smartphone, a tablet PC, or a wearable terminal possessed by a user. The specific type of the client 20 is not limited to the example. The client 20 may be any type of information processing device that can be operated by a user. The client 20 can be implemented, for example, by the hardware configuration described below in (7. Hardware Configuration).

FIG. 1 illustrates the single client 20 alone for the sake of simplicity. However, multiple clients 20 corresponding to multiple users are actually connected to the server 10 via the network in the system 1. In addition, a single user may possess the multiple clients 20.

The server 10 is an information processing device provided, for example, on the network (what is called cloud computing). The server 10 distributes various types of information to a user on the basis of user-sent information and/or user behavior information described below. The server 10 can be implemented, for example, by the hardware configuration described below in (7. Hardware Configuration).

The user-sent information is transmitted from the client 20 to the server 10 in the system 1. Here, the user-sent information is information sent by a user via the client 20 in social media such as bulletin board systems, blogs, and social networking services (SNSs).

In addition, the user behavior information may be further transmitted from the client 20 to the server 10 in the system 1. The user behavior information is information that indicates a behavior of a user acquired by the client 20. The user behavior information includes information on the details of a specific user behavior such as walking, running, being in a vehicle, and stopping by a specific place.

User-sent information for content is an analysis target in the system 1. The server 10 identifies a characteristic of a user about content by relating the acquired user-sent information to the content. The content is, for example, video content or the like such as an event held in a predetermined place at a predetermined date and time, or a TV program broadcast (distributed) at a predetermined date and time.

Characteristic information indicating a characteristic of a user about content includes, for example, user preference information indicating a preference of the user for the content and/or user behavior attribute information indicating a behavior attribute of the user for the content.

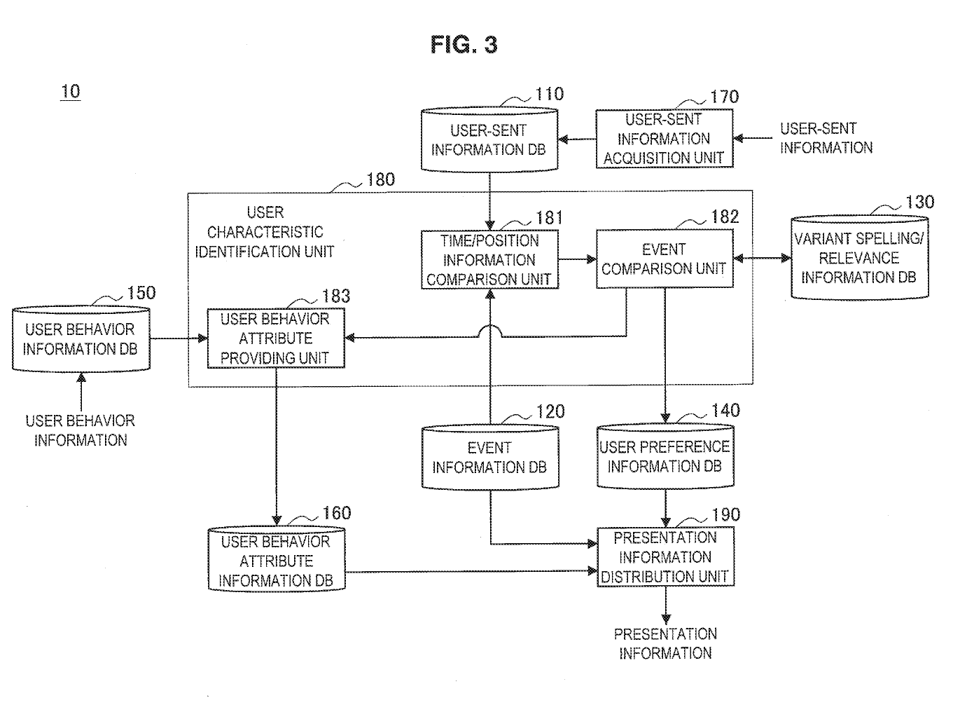

User-sent information for certain content is text data including, for example, an impression or the like of a user about the content, and can serve as an index indicating whether the user is interested in the content. The server 10 can acquire user preference information indicating a preference of a user for content by relating the user-sent information to the content. The processing of relating user-sent information to content, and the acquisition processing of user preference information correspond to the processing performed by an event comparison unit 182 illustrated in FIG. 3 described below. The details of the processing will be therefore described again in detail when the functions of the event comparison unit 182 are described later.

Further, user behavior information of a user who has sent user-sent information for certain content can serve as an index indicating a behavior attribute of the user for the content. The server 10 acquires user behavior information of a user who has sent user-sent information for certain content, and analyzes user behavior information. The server 10 can hereby acquire user behavior attribute information indicating a behavior attribute of the user for the content. The acquisition processing of user behavior attribute information corresponds to the processing performed by a user behavior attribute providing unit 183 illustrated in FIG. 3 described below. The details of the processing will be therefore described again in detail when the functions of the user behavior attribute providing unit 183 are described later.

On the basis of the user preference information and/or the user behavior attribute information for the acquired certain content, presentation information to be presented to a user in relation to the content is distributed from the server 10 to the client 20 in the system 1. The presentation information is information to be presented to a user in a service provided from the server 10 to the client 20 (i.e., user). Examples of the service include a service of recommending merchandise to users, and a service of forming a community on content.

The above-described merchandise recommendation service and community forming service are, however, mere examples of services provided by the server 10. In the present embodiment, the server 10 may also provide another service to a user on the basis of user preference information and/or user behavior attribute information.

For example, in a case where a service provided by the server 10 is the merchandise recommendation service, the server 10 predicts merchandise in which a user is interested, on the basis of the user preference information and/or the user behavior attribute information, and distributes information (such as an advertisement) on the predicted merchandise to the client 20 as presentation information. Further, when distributing the information on the merchandise, the server 10 may decide a user to whom the information on the merchandise is distributed, and the timing at which the information on the merchandise is distributed, on the basis of the user behavior attribute information.

Meanwhile, for example, in a case where a service provided by the server 10 is the community forming service, the server 10 distributes, to the client 20 as presentation information, information for generating a display screen that groups and displays user-sent information of each of users having similar behavior attributes, on the basis of the user behavior attribute information. On the basis of the presentation information, the display screen is provided to a user via a display unit of the client 20.

Additionally, the distribution processing of presentation information corresponds to the processing performed by a presentation information distribution unit 190 illustrated in FIG. 3 described below. The details of the processing will be therefore described again in detail when the functions of the presentation information distribution unit 190 are described later.

The overview of the system 1 according to the present embodiment has been described above with reference to FIG. 1. The following describes the configuration of the server 10, the configuration of the client 20, and a processing procedure of an information processing method executed by the system 1 in more detail, which are illustrated in FIG. 1.

The following describes a case where content is an event held in a predetermined place at a predetermined date and time as an example. The present embodiment is not, however, limited to the example. Content handled by the system 1 may also be other content such as the above-described video content. As described below, processing is performed in some cases in the present embodiment to relate user-sent information to content that the user-sent information targets, on the basis of the time information (user-sent time information) accompanying the user-sent information and the time information (content-sent time information) accompanying the content. It is therefore preferable that content handled by the system 1 be content having time information, for example, like content having the decided date and time at which the content is provided to a user.

### (2. Configuration of Client)

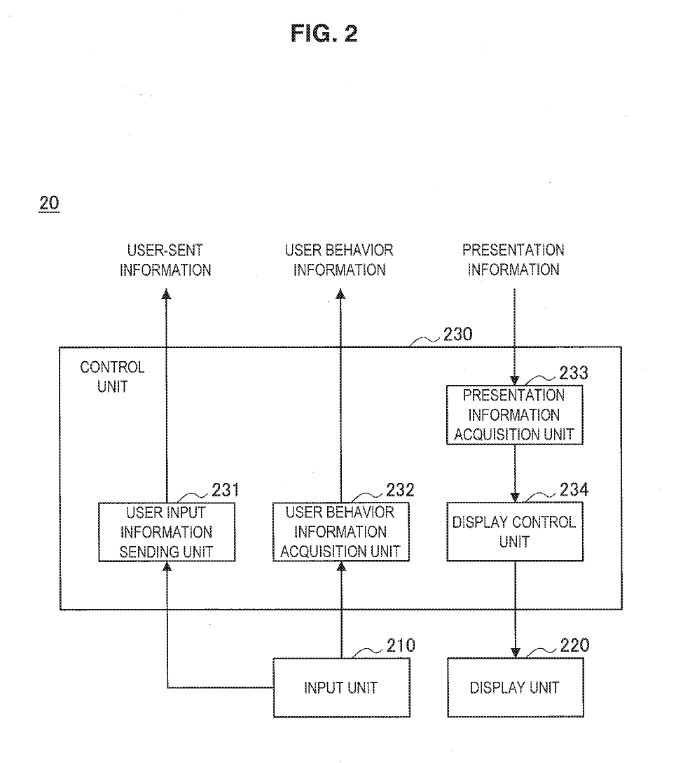

The configuration of the client 20 illustrated in FIG. 1 will be described in more detail with reference to FIG. 2. FIG. 2 is a block diagram illustrating an example of the functional configuration of the client 20 according to the present embodiment.

FIG. 2 illustrates that the client 20 includes an input unit 210, a display unit 220, and a control unit 230 as the functions.

The input unit 210 is an input means for inputting various types of information to the client 20. The input unit 210 includes a variety of input devices such as a mouse, a keyboard, a touch panel, a button, a switch, and a lever. A user can input information such as a post on an event via the input unit 210. Information (user input information) on an event input by a user via the input unit 210 is provided to a user input information sending unit 231 of the control unit 230 described below.

Further, the input unit 210 includes a variety of sensors such as an acceleration sensor, a gyro sensor, a geomagnetic sensor, an optical sensor, a sound sensor, a distance measurement sensor, a force sensor, and a global positioning system (GPS) sensor. The detected values by these sensors are provided to a user behavior information acquisition unit 232 of the control unit 230 described below. Further, the detected value by the GPS sensor may also be provided to the user input information sending unit 231 of the control unit 23 described below as information indicating the position of the client 20 at the time at which the user input information is input, or the position of a user at the time at which the user input information is input.

The display unit 220 is a display means that displays various types of information in a variety of forms such as text and an image, thereby visually outputting the information to a user. The display unit 220 includes a variety of display devices such as a cathode ray tube (CRT) display device, a liquid crystal display device, a plasma display device, and an electro-luminescence display device. The display unit 220 is controlled by a display control unit 234 of the control unit 230 described below to display presentation information distributed from the server 10. The presentation information is, for example, an advertisement of merchandise of the merchandise recommendation service, or information for generating a display screen that displays posts for each community of the community forming service.

The control unit 230 is a control means that controls the operation of the client 20 by executing various types of processing. For example, the control unit 230 includes a variety of processors such as a central processing unit (CPU), a digital signal processor (DSP), and an application specific integrated circuit (ASIC). The processors included in the control unit 230 operate in accordance with predetermined programs, thereby implementing the variety of functions of the control unit 230.

The functions of the control unit 230 will be described in more detail. The control unit 230 includes the user input information sending unit 231, the user behavior information acquisition unit 232, the presentation information acquisition unit 233, and the display control unit 234 as the functions.

The user input information sending unit 231 sends information (user input information) input by a user via the input unit 210. In the present embodiment, the user input information is text data posted by a user. For example, the user input information sending unit 231 sends user input information to existing social media (such as bulletin board systems, blogs, and SNSs). Further, in a case where there is provided an application dedicated to the system 1 according to the present embodiment illustrated in FIG. 1, the user input information sending unit 231 sends user input information to the dedicated server that manages the dedicated application.

The user input information sent by the user input information sending unit 231 is acquired by a user-sent information acquisition unit 170 of the server 10 described below as user-sent information sent by a user via the client 20. Specifically, the user-sent information acquisition unit 170 can acquire the user-sent information, for example, by using existing social media or accessing the above-described dedicated server that manages the dedicated application.

Here, the user input information sending unit 231 can associate the time information on the time at which a user makes a post, for example, with text data serving as the user input information that indicates the content of the post, and send the user input information. The time information can be acquired from the clock function of the client 20 similarly, for example, to a general information processing device. The user-sent information can be accompanied by the time information in this way.

Further, for example, in a case where the position information of a user is provided to the user input information sending unit 231 from the GPS sensor included in the input unit 210, the user input information sending unit 231 can associate the position information on the position at which the user makes the post with the user input information, and send the user input information. The user-sent information may be accompanied by the position information in this way.

The user behavior information acquisition unit 232 estimates a behavior of a user on the basis of the detected values of the variety of sensors, which are provided from the input unit 210, and acquires the user behavior information indicating the behavior of the user. For example, on the basis of the detected values of the acceleration sensor, the gyro sensor, the GPS sensor, and the like, the user behavior information acquisition unit 232 can estimate whether a user is walking, running, or staying in a given place. Further, for example, the user behavior information acquisition unit 232 can estimate that a user is in a vehicle (such as an automobile or a train), by detecting a change in the position information of the user on the basis of the detected values of the GPS sensor and the like. Besides, the user behavior information acquisition unit 232 can acquire user behavior information by using a variety of known methods that can be generally used to estimate behaviors of users. As a method for acquiring user behavior information, for example, the method disclosed in JP 2011-81431A can be used, which is a prior application of the Applicant of the present application.

The user behavior information acquisition unit 232 transmits the acquired user behavior information to a user behavior information DB 150 of the server 10 described below.

The presentation information acquisition unit 233 acquires presentation information distributed from the server 10. The presentation information is information to be presented to a user in relation to an event for which the user makes a post or the like. As described above, the presentation information is, for example, an advertisement of merchandise of the merchandise recommendation service, or information for generating a display screen of the community forming service. The presentation information acquisition unit 233 provides the acquired information to the display control unit 234.

The display control unit 234 controls the driving of the display unit 220, and causes the display unit 220 to display various types of information in a variety of forms such as text and an image. In the present embodiment, the display control unit 234 causes the display unit 220 to display the presentation information provided from the presentation information acquisition unit 233. This provides an advertisement of merchandise or a display screen of the community forming service to a user.

The functional configuration of the client 20 has been described above. FIG. 2 chiefly illustrates only the functions relating to the processing executed by the system 1 according to the present embodiment described with reference to FIG. 1 for the sake of simplicity, but the other functions are not illustrated. The client 20 has a variety of known functions of a general information processing device in addition to the illustrated functions. For example, the client 20 may have the functions of a communication unit that exchanges various types of information with the server 10, a storage unit that stores various types of information to be processed by the control unit 230, and the like as functions that are not illustrated. The functions that are not illustrated may be similar to functions that are generally known as known functions. Accordingly, the details of the functions that are not illustrated will not be described.

### (3. Configuration of Server)

The configuration of the server 10 illustrated in FIG. 1 will be described in more detail with reference to FIG. 3. FIG. 3 is a block diagram illustrating an example of the functional configuration of the server 10 according to the present embodiment.

FIG. 3 illustrates that the server 10 includes a user-sent information DB 110, an event information DB 120, a variant spelling/relevance information DB 130, a user preference information DB 140, a user behavior information DB 150, a user behavior attribute information DB 160, the user-sent information acquisition unit 170, a user characteristic identification unit 180, and the presentation information distribution unit 190 as the functions.

Here, the user-sent information DB 110, the event information DB 120, the variant spelling/relevance information DB 130, the user preference information DB 140, the user behavior information DB 150, and the user behavior attribute information DB 160 include a variety of storage devices such as magnetic storage devices including hard disk drives (HDDs), semiconductor storage devices, optical storage devices, or magneto-optical storage devices, and are storage means that store various types of information.

The user-sent information acquisition unit 170, the user characteristic identification unit 180, and the presentation information distribution unit 190 include a variety of processors such as CPUs, DSPs, and ASICs, and are control means that control the operation of the server 10 by executing various types of processing. The processors included in the user-sent information acquisition unit 170, the user characteristic identification unit 180, and the presentation information distribution unit 190 operate in accordance with predetermined programs, thereby implementing the functions of the user-sent information acquisition unit 170, the user characteristic identification unit 180, and the presentation information distribution unit 190 described below.

### (User-Sent Information Acquisition Unit 170)

The user-sent information acquisition unit 170 acquires information set by a user via the client 20, namely, user input information sent from the user input information sending unit 231 of the client 20 as user-sent information. In the present embodiment, the user-sent information is text data posted by a user. For example, in a case where a user makes a post in existing social media, the user-sent information acquisition unit 170 uses the social media to acquire the user-sent information. Further, for example, in a case where there is provided an application dedicated to the system 1 according to the present embodiment illustrated in FIG. 1, and a user uses the dedicated application to make a post, the user-sent information acquisition unit 170 can acquire the user-sent information by accessing the dedicated server that manages the dedicated application.

As described in (2. Configuration of Client), the user-sent information may be accompanied by the time information on the time at which the user-sent information is sent and/or position information on the position at which the user-sent information is sent. Here, the processing of associating the time information and/or the position information with the user-sent information is a function implemented in some of existing social media. The user-sent information acquisition unit 170 may thus use the function implemented in the existing social media to acquire the user-sent information accompanied by the time information and/or the position information. Alternatively, in a case where there is provided an application dedicated to the system 1 according to the present embodiment illustrated in FIG. 1, the user-sent information acquisition unit 170 may acquire the user-sent information accompanied by the time information and/or the position information provided by the user input information sending unit 231 of the client 20 illustrated in FIG. 2 as a function of the dedicated application.

Some of existing social media can, however, permit users to freely set whether the users concurrently send position information when sending posts. In a case where the setting permits no position information to be sent, the user-sent information can do without any position information. Further, in a case where the client 20 possessed by a user includes no position sensor such as a GPS sensor, the user-sent information can do without any position information.

The user-sent information acquisition unit 170 stores the acquired user-sent information in the user-sent information DB 110.

### (User-Sent Information DB 110)

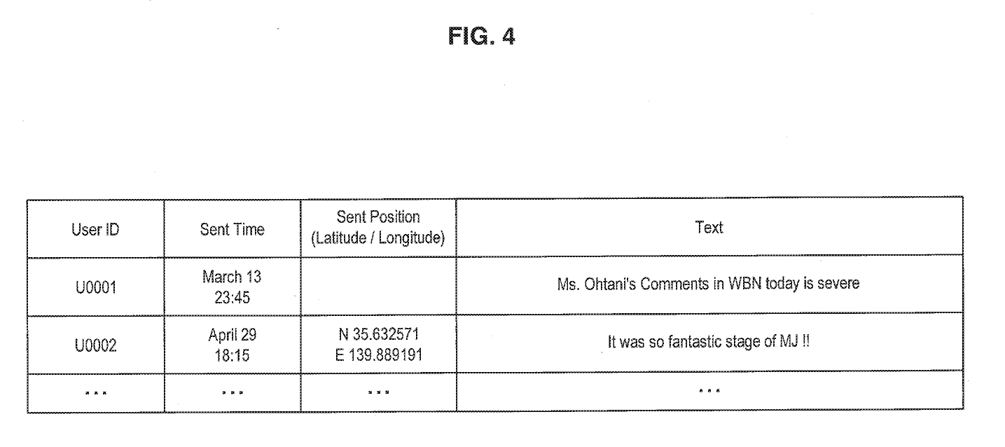

The user-sent information DB 110 is a database (DB) that stores user-sent information acquired by the user-sent information acquisition unit 170. FIG. 4 illustrates an example of user-sent information stored in the user-sent information DB 110. FIG. 4 is a diagram illustrating an example of user-sent information stored in the user-sent information DB 110. FIG. 4 also illustrates an example of user-sent information for video content described below in (6. Modification).

As illustrated in FIG. 4, text data indicating the content of a post that is user-sent information and made by a user, and the user ID for identifying a user who makes the post are retained in association with each other in the user-sent information DB 110. Further, the time information and/or the position information is associated with the user-sent information and managed in the user-sent information DB 110. In the example illustrated in FIG. 4, the sent time of the user-sent information, and the latitude and longitude of the sent place of the user-sent information are retained in association with the text data indicating the content of a post made by a user. Time information such as the sent time that accompanies the user-sent information will also be referred to as user-sent time information. Meanwhile, position information such as the sent place that accompanies the user-sent information will also be referred to as user-sent position information.

However, as described above, the position information does not necessarily have to accompany the user-sent information. In such a case, as illustrated in FIG. 4, the user-sent information accompanied by no position information can be stored in the user-sent information DB 110.

### (Event Information DB 120)

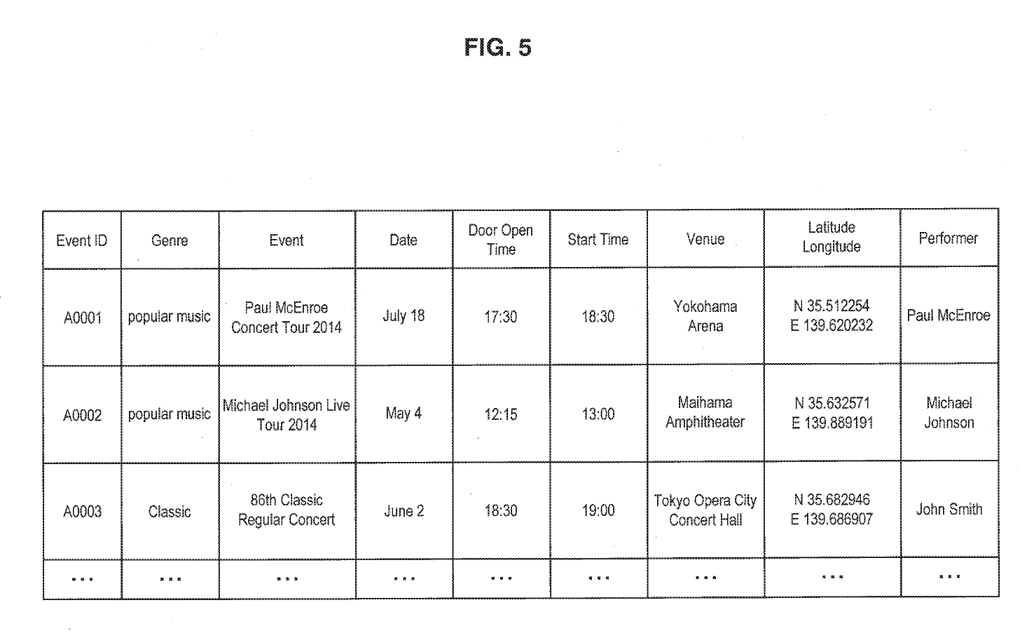

The event information DB 120 is a DB that stores various types of information (event information) on an event. FIG. 5 illustrates an example of event information stored in the event information DB 120. FIG. 5 is a diagram illustrating an example of event information stored in the event information DB 120.

As illustrated in FIG. 5, the event information DB 120 retains, as event information, the event IDs for identifying events, the genres of events, the names of events, the dates of events, the door open time of events, the names of the venues of events, the places (latitude and longitude) of event venues, and the performers of events in association with each other. Time information such as the door open time of events and the start time of events which accompany the events will also be referred to as event time information. Further, position information such as the places of event venues which accompany the events will also be referred to as event position information. As the event information DB 120, a variety of existing DBs can be used that are generally managed by dealers such as ticket agencies which sell the tickets of events.

### (User Behavior Information DB 150)

The user behavior information DB 150 is a database (DB) that stores user behavior information acquired by the user behavior information acquisition unit 232 of the client 20 illustrated in FIG. 2. For example, the user IDs for identifying users, the user behavior information of users, the time information on the time at which user behavior information is acquired, and the position information on the position at which user behavior information is acquired are associated with each other and retained as user behavior information in the user behavior information DB 150.

### (User Characteristic Identification Unit 180)

The user characteristic identification unit 180 identifies a characteristic of a user for an event by relating user-sent information for the event with the event. Specifically, the user characteristic identification unit 180 can identify for which event the user-sent information is sent, by comparing the user-sent information with events, and identify a characteristic of a user about the event on the basis of the relationship between the identified user-sent information and the event.

Characteristic information indicating a characteristic of a user about an event includes user preference information and/or user behavior attribute information. An event for which a user sends information can be regarded as an event in which the user is interested. Accordingly, the user characteristic identification unit 180 can acquire user preference information from a result obtained by relating the user-sent information to the event. Further, the user characteristic identification unit 180 can acquire user behavior attribute information for an event by relating the user-sent information to the event, and analyzing the user behavior information of the user who sends the user-sent information for the event.

The functions of the user characteristic identification unit 180 will be described in more detail. As illustrated in FIG. 3, the user characteristic identification unit 180 includes a time/position information comparison unit 181, the event comparison unit 182, and the user behavior attribute providing unit 183 as the functions.

### (Time/Position Information Comparison Unit 181)

On the basis of the user-sent time information accompanying user-sent information, the time/position information comparison unit 181 extracts a candidate for the event corresponding to the user-sent information. Specifically, the time/position information comparison unit 181 first accesses the user-sent information DB 110, thereby acquiring user-sent information (i.e., text data indicating a post) and the accompanying user-sent time information. Next, the time/position information comparison unit 181 uses the acquired user-sent time information to search the event information DB 120, and extracts a candidate for the event corresponding to the user-sent information of the user-sent time information from the events registered in the event information DB 120.

For example, there is a relatively strong possibility that the user-sent information sent before or after the time at which an event is held is user-sent information sent for the event. In a case where the user-sent time information and the event time information form a predetermined relationship, the time/position information comparison unit 181 can therefore determine that the user-sent information of the user-sent time information has relevance to the event of the event time information.

For example, in a case where the sent time of the user-sent information is included within the period of time from x hours before the door open time of an event to y hours after the start time of the event, the time/position information comparison unit 181 determines that the user-sent information has relevance to the event, and extracts the event as a candidate for the event corresponding to the user-sent information. In this way, the time/position information comparison unit 181 can extracts a candidate for the event corresponding to the user-sent information by comparing the user-sent time information with the event time information. The thresholds x and y serving as determination standards may be set as appropriate by a user, a designer of the system 1, or the like, for example, in accordance with the type of event, the scale of an event, or the like.

Here, further on the basis of the user-sent position information accompanying user-sent information, the time/position information comparison unit 181 may extract a candidate for the event corresponding to the user-sent information. Specifically, like the time/position information comparison unit 181 does using user-sent time information, the time/position information comparison unit 181 first accesses the user-sent information DB 110, thereby acquiring the user-sent information and the accompanying user-sent position information. Next, the time/position information comparison unit 181 uses the acquired user-sent position information to search the event information DB 120, and extracts a candidate for the event corresponding to the user-sent information of the user-sent position information from the events registered in the event information DB 120.

For example, there is a relatively strong possibility that the user-sent information sent around the place in which an event is held is user-sent information sent for the event. In a case where the user-sent position information and the event position information form a predetermined relationship, the time/position information comparison unit 181 can therefore determine that the user-sent information has relevance to the event.

For example, in a case where the sent place of the user-sent information falls within z (km) in a straight line from the venue of an event, the time/position information comparison unit 181 determines that the user-sent information has relevance to the event, and extracts the event as a candidate for the event corresponding to the user-sent information. As illustrated in FIGS. 4 and 5, in a case where the sent place of the user-sent information and the place of the event venue are expressed in the form of latitude and longitude, the time/position information comparison unit 181 can calculate the distance in a straight line between both places on the basis of the latitude and longitude.

In this way, the time/position information comparison unit 181 can extracts a candidate for the event corresponding to the user-sent information by comparing the user-sent position information with the event position information. The threshold z serving as a determination standard may be set as appropriate by a user, a designer of the system 1, or the like, for example, in accordance with the type of event, the scale of an event, or the like. For example, it is predicted that the distance between the sent place of the user-sent information and the venue of the event depends on the elapsed time since the event finish time, and the distance increases with the lapse of time. The threshold z can therefore be set as a function of the elapsed time t since the event finish time. For example, the function is expressed as z(t)32 at+b (where a and b represent any natural numbers).

The time/position information comparison unit 181 provides the event comparison unit 182 with the user-sent information and information on the extracted candidate for the event corresponding to the user-sent information.

### (Event Comparison Unit 182)

The event comparison unit 182 determines the identity of a word in the text data of the user-sent information with a word in the text data included in the event information of the extracted event, thereby relating the user-sent information to the event. In the present embodiment, the event comparison unit 182 relates the user-sent information to the event, for example, in the following processing procedure. A specific technique performed by the event comparison unit 182 for the processing of relating user-sent information to an event is not, however, limited to the following example. Any known techniques that can be generally used for so-called name identification processing may be used for the relating processing.

First, the event comparison unit 182 extracts a named entity from the text data of the user-sent information. The named entity is a concept generally used in the field of natural language processing, and corresponds to a word that indicates a proper noun, a date, time, or the like in text data. Since a variety of known techniques can be used as the processing of extracting a named entity from text data, the details thereof will not be described here.

Next, the event comparison unit 182 combines the named entity extracted from the text data of the user-sent information with a word in the text data included in event information as a search word, and carries out an Internet search. Any existing web search engines may be used as a web search engine used for the Internet search.

For example, “MJ” can be extracted as a named entity from user-sent information sent by the user having the user ID U0002 illustrated in FIG. 4. Some techniques for named entity extraction processing can identify even the part of speech of a word and the concept of the word (e.g., whether the word is a person's name or an event name) when extracting the word as a named entity. The “MJ” can therefore be extracted as a person's name (which will be described as “MJ (person's name).” The same applies to other named entities).

Meanwhile, words such as “Paul McEnroe Concert Tour 2014 (event name),” “Michael Johnson Live Tour 2014 (event name),” “86th Classic Regular Concert (event name),” “Paul McEnroe (person's name),” “Michael Johnson (person's name),” and “John Smith (person's name)” can be extracted from the event information in the event information DB 120 illustrated in FIG. 5. The event comparison unit 182 creates, for example, the following search words between “MJ (person's name)” extracted from the user-sent information, and the words such as “Paul McEnroe Concert Tour 2014 (event name),” “Michael Johnson Live Tour 2014 (event name),” “86th Classic Regular Concert (event name),” “Paul McEnroe (person's name),” “Michael Johnson (person's name),” and “John Smith (person's name)” extracted from the event information, and executes search processing.

Search Word 1: Paul McEnroe Concert Tour 2014 (event name) & MJ (person's name)”
Search Word 2: “Michael Johnson Live Tour 2014 (event name) & MJ (person's name)”
Search Word 3: “86th Classic Regular Concert (event name) & MJ (person's name)”
Search Word 4: “Paul McEnroe (person's name) & MJ (person's name)”
Search Word 5: “Michael Johnson (person's name) & MJ (person's name)”
Search Word 6: “John Smith (person's name) & MJ (person's name)”

Next, the event comparison unit 182 determines whether the number of web pages obtained as a search result exceeds a predetermined threshold. The number of search-resultant web pages exceeding the predetermined threshold means that the named entities extracted from the user-sent information and the words included in the event information are frequently written on the same web pages. Accordingly, it is considered that the named entities and the words have high relevance to each other. There is thus a strong possibility that the user-sent information from which the named entities used as search words are extracted is sent for the events from which the words used as the same search words are extracted. Conversely, in a case where the number of search-resultant web pages is less than or equal to the predetermined threshold, it is considered that the named entities extracted from the user-sent information has low relevance to the words included in the event information, and there is a weak possibility that the user-sent information from which the named entities used as search words are extracted is sent for the events from which the words used as the same search words are extracted. Accordingly, in a case where the number of search-resultant web pages exceeds the predetermined threshold, the event comparison unit 182 relates the user-sent information from which the named entities used as search words are extracted to the events from which the words used as the same search words are extracted.

The above-described search words 1 to 6 are used as examples. It is assumed that the number of web pages resulting from the searches with the search words 2 and 5 exceeds the predetermined threshold, while the number of web pages resulting from the searches with the search words 1, 3, 4, and 6 is less than or equal to the predetermined threshold. In that case, the event comparison unit 182 determines that the user-sent information which “MJ (person's name)” is extracted from, and which is sent by the user having the user ID U0002 illustrated in FIG. 4 has high relevance to the event which “Michael Johnson Live Tour 2014 (event name)” and “Michael Johnson (person's name)” are extracted from, and which is the event having the event ID A0002 illustrated in FIG. 5, and relates the user-sent information and the event.

In this way, processing is performed to determine the identity of a word in the text data of the user-sent information with a word in the text data included in the event information of the extracted event, in the processing of relating user-sent information to an event which is performed by the event comparison unit 182. Such processing of identifying pieces of different data as data referring to the same entity is generally referred to as name identification. The advantageous effects can be obtained in the present embodiment that the time/position information comparison unit 181 and the event comparison unit 182 use user-sent time information to extract candidates for an event, and then determine the identity of the words with each other, thereby relating the user-sent information to the event more accurately than the existing name identification techniques allow. This further advantageous effect achieved by the time/position information comparison unit 181 and the event comparison unit 182 will be described again below in (4. Consideration of Processing of Relating User-sent Information to Event).

The event comparison unit 182 relates user-sent information to an event, and then stores the user of the related user-sent information and the event in the user preference information DB 140 in association with each other as user preference information indicating an interest of the user. This is because the user is a user who sends information for the event, and the user is then considered to be a user who is interested in the event. At this time, the event comparison unit 182 also provides information on the associated user and event to the user behavior attribute providing unit 183. The user behavior attribute providing unit 183 acquires behavior attribute information of the user for the associated event.

The event comparison unit 182 stores, in the variant spelling/relevance information DB 130 as variant spelling/relevance information, the combination of a named entity and a word which are considered to have high relevance on the basis of a search result. Here, the variant spelling/relevance information is information indicating the relationship of variant spellings of the same object. This is because the combination of a named entity and a word that are considered to have high relevance on the basis of a search result is considered to indicate variant spellings of the same object.

### (User Preference Information DB 140 and Variant Spelling/Relevance Information DB 130)

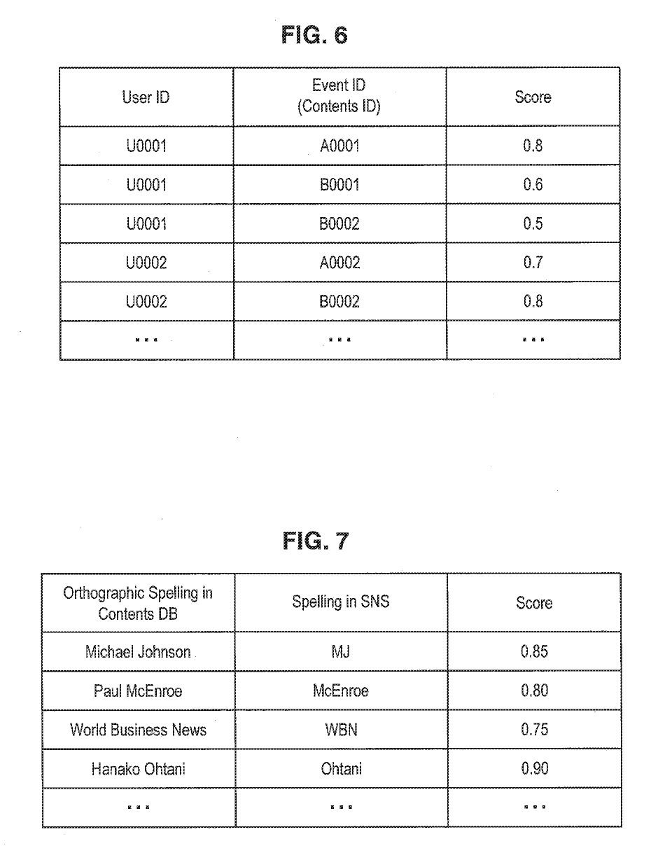

FIG. 6 illustrates an example of user preference information stored in the user preference information DB 140. FIG. 6 is a diagram illustrating an example of user preference information stored in the user preference information DB 140. Further, FIG. 7 illustrates an example of variant spelling/relevance information stored in the variant spelling/relevance information DB 130. FIG. 7 is a diagram illustrating an example of variant spelling/relevance information stored in the variant spelling/relevance information DB 130. FIGS. 6 and 7 also illustrate an example of user preference information and variant spelling/relevance information for video content described below in (6. Modification).

As illustrated in FIG. 6, the user preference information DB 140 retains, as user preference information, the user ID for identifying a user, the event ID for identifying an event, and the score indicating the strength degree of a preference of the user for the event in association with each other to indicate that the user and the event are related to each other. The score can be decided, for example, in accordance with how many times user-sent information is sent for the same event or a relevant event (such as a different event of the same performer). This is because a user who makes more posts on a certain event is considered to be a user who is interested in the event or a similar event to the event.

Meanwhile, as illustrated in FIG. 7, the variant spelling/relevance information DB 150 retains, as variant spelling/relevance information, a spelling of the same object in the user-sent information (post), a spelling in the event information, and the score indicating the strength degree of the relevance between these spellings in association with each other. The higher score means that there is a stronger possibility that a variant spelling refers to the same object or the spellings have higher relevance. The score can be decided, for example, in accordance with how many times, as a result obtained by performing, on user-sent information of users, the above-described determination processing of the identity of named entities in the user-sent information with words in event information, the event comparison unit 182 determines that the named entities have high relevance to the words.

The above-described search words 1 to 6 are used as examples. As described above, it is assumed that the event comparison unit 182 determines that user-sent information sent by the user having the user ID U0002 illustrated in FIG. 4 has high relevance to the event having the event ID A0002 illustrated in FIG. 5, and relates the user-sent information to the event. In this case, the event comparison unit 182 retains the user ID: U0002 and the event ID: A0002 in the user preference information DB 140 in association with each other on the basis of the related user-sent information and event. The event comparison unit 182 also computes the score indicating the strength degree of a preference of the user for the event, relates the score to the user ID and the event ID, and retains the score in the user preference information DB 140.

On the basis of search results for the search words 1 to 6, the event comparison unit 182 can determine in the process of the processing of relating the user-sent information to the event that “MJ (person's name)” has high relevance to “Michael Johnson Live Tour 2014 (event name),” and “MJ (person's name)” has high relevance to “Michael Johnson (person's name).” The event comparison unit 182 determines that “MJ (person's name)” and “Michael Johnson (person's name),” which are both person's names, in the combinations of words that are determined to have high relevance are variant spellings of the same object, and retains these words in the variant spelling/relevance information DB 150 in association with each other. The event comparison unit 182 also computes the score indicating the strength degree of the relevance between these words, relates the score to “MJ (person's name)” and “Michael Johnson (person's name),” and retains the score in the variant spelling/relevance information DB 150.

User preference information stored in the user preference information DB 140 is part of characteristic information indicating a characteristic of a user about an event. The user preference information can be used for the presentation information distribution unit 190 to perform the distribution processing of presentation information.

Meanwhile, variant spelling/relevance information stored in the variant spelling/relevance information DB 130 can be used for the event comparison unit 182 to perform the following processing of relating user-sent information to an event. For example, in a case where a named entity extracted from user-sent information and a word extracted from event information are variant spellings of the same object, and have already been retained in the variant spelling/relevance information DB 130, the event comparison unit 182 does not have to perform the above-described search processing, but may determine the identity of the named entity with the word by referring to the variant spelling/relevance information in the variant spelling/relevance information DB 130. In this way, in the present embodiment, as the repeated processing of relating user-sent information to an event enriches the variant spelling/relevance information DB 130, it is possible to perform the relating processing without any access to the outside like the Internet search, and to more efficiently perform the relating processing.

### (User Behavior Attribute Providing Unit 183)

The user behavior attribute providing unit 183 provides a behavior attribute to a user on the basis of user behavior information, thereby acquiring user behavior attribute information indicating the behavior attribute of the user for an event. The behavior attribute of a user is, for example, a residential place attribute indicating the area of the residential place of the user, a workplace attribute indicating the area of the workplace of the user, a stopping-by place attribute based on the fact that the user stops by a specific store before or after an event, a traffic means attribute based on a traffic means used for the user to go to an event venue, and the like. The present embodiment is not, however, limited to these examples. Any other behavior attributes may be provided.

For example, the user behavior attribute providing unit 183 acquires, from the user behavior information DB 150, the history of the position information of a user to whom a behavior attribute is provided. The history of the position information is included in the user behavior information of the user. The user behavior attribute providing unit 183 estimates, as the home area of the user, the area in which the user is staying for a given period of time or more in the nighttime, on the basis of the history of the position information. The user behavior attribute providing unit 183 then provides a residential place attribute to the user in accordance with the estimated home area of the user. The user behavior attribute providing unit 183 estimates, as the workplace area of the user, the area in which the user is staying for a given period of time or more in the daytime, on the basis of the history of the position information, and then provides a workplace attribute to the user in accordance with the estimated workplace area of the user. Residential place attributes and workplace attributes may be categorized, for example, in units of prefectures, or more broadly categorized in units of regions such as “Kanto area” and “Kansai area.”

Further, for example, the user behavior attribute providing unit 183 acquires, from the user behavior information DB, the user behavior information of a path that a user to whom a behavior attribute is provided takes between an event venue and the home (i.e., a route taken by a user) before or after the start time of the event. The user behavior information of a path is included in the user behavior information of the user. It can be determined in which event the user participates, in accordance with a result obtained by the event comparison unit 182 relating the user-sent information to the event. The user behavior attribute providing unit 183 cooperates with geographic information system (GIS), thereby forming the relationship between the user behavior information and various types of geographic information. The user behavior attribute providing unit 183 uses GIS information to compare a route taken by a user with a public traffic means, and provides a traffic means attribute to the user. Traffic means attributes are categorized for each of traffic means such as “train,” “bus,” and “taxi.” At this time, for example, in a case where the route taken by the user deviates from the routes of a train and a bus, and the user is considered to be in an automobile on the basis of the moving speed of the position information of the user, “taxi” is selected as a traffic means attribute.

Further, for example, in a case where the information on the route taken by the user shows that the user is staying in some place for a given period of time or more before and/or after the start or end of the event, the user behavior attribute providing unit 183 uses the GIS information to identify the type of that staying place, and provides the type of that staying place to the user as a stopping-by place attribute. For example, a restaurant, a convenience store, or the like is identified as the type of staying place. Further, “food and drink,” “convenience store,” or the like is provided as a behavior attribute in accordance with the type of staying place.

The user behavior attribute providing unit 183 stores the acquired user behavior attribute information in the user behavior attribute information DB 160.

### (User Behavior Attribute Information DB 160)

The user behavior attribute information DB 160 is a DB that stores user behavior attribute information acquired by the user behavior attribute providing unit 183. The user behavior attribute information DB 160 retains, as user behavior attribute information, for example, the user ID for identifying a user, and a behavior attribute provided to the user in association with each other.

### (Presentation Information Distribution Unit 190)

The presentation information distribution unit 190 distributes, to the client 20 illustrated in FIG. 2, presentation information to be presented to a user in relation to an event identified by the user characteristic identification unit 180 on the basis of a characteristic of the user (such as a preference of the user and/or a behavior attribute of the user) for the event. As described above in (1. Overview of System), the presentation information may be an advertisement of a recommendation service, information for generating a display screen of the community forming service, or the like. The present embodiment is not, however, limited to these examples. Presentation information may be generated as appropriate in accordance with a service provided by the server 10 to a user.

For example, in a case where a service provided by the server 10 is the merchandise recommendation service, the presentation information distribution unit 190 predicts merchandise in which a user is interested, on the basis of the user preference information and/or the user behavior attribute information, and distributes information on the predicted merchandise to the client 20 as presentation information. The information on the merchandise may be an advertisement of content of a similar type to the type of content for which the user sends user-sent information, a coupon of a restaurant, or an advertisement of a traffic means. Since a variety of prediction engines used in general recommendation services may be used for the merchandise prediction, the details thereof will not be described.

Further, when distributing the information on the merchandise, the presentation information distribution unit 190 may decide a user to whom the information on the merchandise is distributed, and the timing at which the information on the merchandise is distributed, on the basis of the user behavior attribute information. For example, the presentation information distribution unit 190 can distribute a coupon of a restaurant around an event venue immediately after the end of the event to a user (a user having the behavior attribute “food and drink”) who has the behavior attribute of stopping by a restaurant around a specific store event venue on the way home after participating in the event. Further, for example, the presentation information distribution unit 190 can distribute a coupon of a restaurant around an event venue immediately after the end of the event to a user (a user having the behavior attribute “food and drink”) who has the behavior attribute of stopping by a convenience store on the way home after participating in the event.

The presentation information distribution unit 190 may also distribute information on merchandise depending on the residential place of a user on the basis of user behavior attribute information. For example, the presentation information distribution unit 190 can distribute advertisements of the corresponding traffic means such as airplanes and Shinkansen to users who live in places remote from an event venue.

Meanwhile, for example, in a case where a service provided by the server 10 is the community forming service, the presentation information distribution unit 190 distributes, to the client 20 as presentation information, information for generating a display screen that groups and displays user-sent information of each of users having similar behavior attributes, on the basis of the user behavior attribute information. The display unit 220 of the client 20 illustrated in FIG. 2 displays a display screen in which, for example, posts made by a user for a certain event are grouped for each behavior attribute on the basis of the presentation information. This facilitates users to communicate with each other such as sharing information on restaurants around the venue of an event between users who have, for example, the behavior attribute of stopping by a restaurant on the way home after participating in the event, and sharing opinions about content between users who live in the same residential place areas.

The configuration of the server 10 illustrated in FIG. 1 has been described in more detail above with reference to FIG. 3. As described above, according to the present embodiment, the user characteristic identification unit 180 identifies a characteristic of a user about an event by relating user-sent information sent by the user for the event to the event. On the basis of the characteristic information indicating the characteristic of the user identified by the presentation information distribution unit 190, presentation information to be presented to the user in relation to the event is distributed. Relating the user-sent information to the event makes it possible to more precisely distribute the presentation information on the event to a user who participates in the event. Accordingly, users can obtain information more necessary for the users themselves, and the convenience of the users is improved.

Further, the characteristic information may include the user preference information and/or the user behavior attribute information in the present embodiment. At this time, the presentation information may be information on merchandise (such as an advertisement or a coupon). The information on merchandise is distributed on the basis of the user preference information, thereby more precisely distributing information on merchandise in which a user is interested to the user. The information on merchandise is distributed on the basis of the user behavior attribute information, thereby timely and more precisely distributing information on merchandise that a user desires at certain timing to the user. This further improves the convenience of the user.

Further, as presentation information presentation information, information may be distributed that is used for generating a display screen in which user-sent information is grouped and displayed for each of users having similar behavior attributes on the basis of the user behavior attribute information in the present embodiment. The display screen based on the presentation information groups and displays, for example, posts for a certain event for each behavior attribute. Accordingly, users who tend to similarly behave before or after the event are facilitated to form a community, and to further send information in the community. According to the present embodiment, it is possible to form a community more useful for users in this way.

The device configuration of the system 1 according to the present embodiment is not limited to the examples illustrated in FIGS. 2 and 3. For example, the respective functions of the client 20 illustrated in FIG. 2 do not necessarily have to be installed in a single device integrally. The respective functions installed in the client 20 illustrated in FIG. 2 may be distributed to multiple devices (such as multiple devices possessed by a user), and the multiple devices may be communicably connected to each other via a network to implement the above-described functions of the client 20. For example, among the functions of the client 20, a mobile terminal such as a smartphone may receive information and send user input information (the functions corresponding to the above-described input unit 210 and user input information sending unit 231), and a stationary device in the house of a user such as a desktop PC or a television device may acquire presentation information and display the presentation information (the functions corresponding to the above-described presentation information acquisition unit 233, display control unit 234, and display unit 220).

Similarly, the respective functions of the server 10 illustrated in FIG. 3 do not necessarily have to be installed on a single device integrally. The respective functions installed in the server 10 illustrated in FIG. 3 may be distributed to multiple devices, and the multiple devices may be communicably connected to each other via a network to implement the above-described functions of the server 10.

It is possible to make a computer program for implementing each function of the system 1 according to the present embodiment as mentioned above, and then implement the computer program in a personal computer. There can also be provided a computer-readable recording medium having the computer program stored therein. Examples of the recording medium include a magnetic disk, an optical disc, a magneto-optical disk, and a flash memory. The computer program may also be distributed via a network, for example, using no recording medium.

### (4. Consideration of Processing of Relating User-sent Information to Event)

Here, the processing performed for the above-described time/position information comparison unit 181 and event comparison unit 182 to relate user-sent information to an event will be considered in more detail.

Services have been recently gaining widespread use that allow users to freely post and send experiences, opinions, and the like of the users via social media such as blogs and SNSs. Such user-sent information sent by users can serve as an important source for estimating interests and behaviors of the individual users. In particular, proper nouns and tags included in the posts are important sources for estimating interests and behaviors of the users.

Users do not, however, write correct proper nouns in private posts and freely attached tags in many cases. Inconsistent spellings or the use of variants (such as nicknames and abbreviations) causes proper nouns and tags that originally refer to the same object to be variant spellings in many cases. Slangs or the like accepted only in a community are frequently used especially in social media such as SNSs, causing variant spellings. It is thus difficult to correctly link proper nouns and tags in posts of users to the referents of the proper nouns, and there is a concern that it is impossible to efficiently use user-sent information.

Accordingly, there are a variety of methods proposed for the name identification processing of determining the identity of proper nouns expressed as variant spellings. For example, JP 2010-26996A discloses a tagging support device that automatically tags content, makes, in advance, a DB of characteristic phrases which represent relatively broad concepts and can serve as tags, and selects a phrase serving as a tag from the phrases in the DB in accordance with a topic in content to prevent each user from setting original tags at random. Further, JP 2010-231253A discloses a method of carrying out searches with respect to words that seem to have inconsistent spellings by using these words as search words, and using proper nouns such as place names, addresses, and persons' names obtained as results of the searches in documents as basis information to determine the identity of these words.

The technique described in JP 2010-26996A, however, has to create, in advance, a DB in which words are registered that correspond to topics in content and serve as candidates for tags. It is thus impossible to unify tags for content that includes topics which are not covered by the DB.

Further, for example, in a case where the name identification processing is performed on corporation names, the method described in JP 2010-231253A requires patterns indicating what type of description is used as basis information to identify the identity of words (e.g., organization names or persons' names obtained as results of searches in documents are used as basis information) to be set in advance in accordance with the types of words. Some patterns therefore have to be prepared in advance in accordance with the types of words on which name identification is performed, which is not versatile. It is also difficult to comprehensively prepare a pattern for every word.

In this way, the existing methods as described in JP 2010-26996A and JP 2010-231253A are effective in a case where words or tags on which name identification is performed can be predicted in advance, but it is difficult to accurately perform name identification on private posts such as posts made via social media which can have words written as any spellings.

Meanwhile, as described above, when name identification is performed on words in user-sent information and words in event information, the time/position information comparison unit 181 first extracts a candidate for an event that user-sent information targets, on the basis of the user-sent time information in the present embodiment. The processing of determining identity is then performed between a word in the event information of the extracted event and a word in the user-sent information. In this way, name identification is not performed on the basis of text data alone in the present embodiment, but the metadata of the user-sent time information is used to narrow down targets to the event corresponding to the user-sent time information for the name identification between a word in the user-sent information and a word in the event information. It is thus possible to more accurately determine the identity of words.

As the identity of a word in user-sent information with a word in event information is more accurately determined, the user-sent information is more accurately related to the event, and a user behavior attribute is more accurately provided by using the user preference information in the user preference information DB 140 and a relating result. The content of presentation information, the distribution timing of presentation information, and the like consequently follow a preference of a user more, and the convenience of a user is further improved.

### (5. Information Processing Method)

Next, the processing procedure of an information processing method executed by the system 1 according to the present embodiment illustrated in FIG. 1 will be described. The following first describes the overview of the processing procedure of the information processing method executed by the system 1. The following then describes the processing procedure of each processing executed by the server 10 in the information processing method in more detail.

### (5-1. Information Processing Method in System)

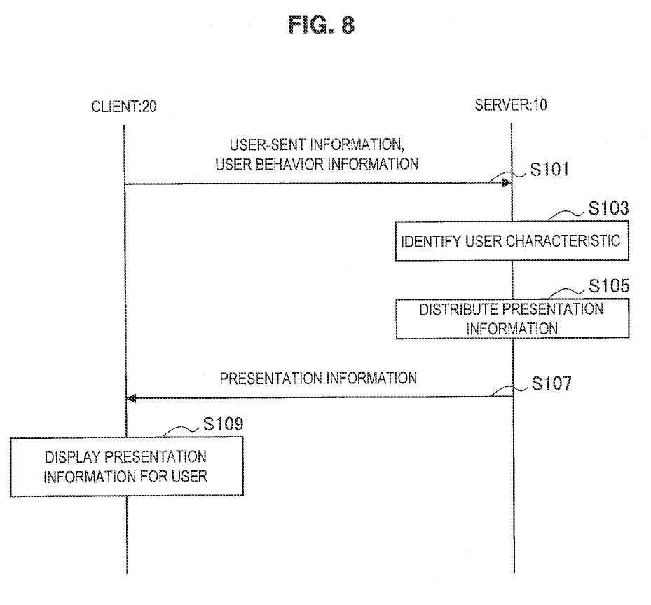

The processing procedure of an information processing method executed by the system 1 according to the present embodiment illustrated in FIG. 1 will be described with reference to FIG. 8. FIG. 8 is a sequence diagram illustrating an example of a processing procedure of the information processing method according to the present embodiment. Additionally, each processing illustrated in FIG. 8 can be executed by the respective functions of the client 20 and the server 10 illustrated in FIGS. 2 and 3.

FIG. 8 illustrates that the client 20 first transmits user-sent information, and the server 10 acquires the user-sent information in the information processing method according to the present embodiment (step S101). The processing shown in step S101 corresponds to the processing executed, for example, by the user input information sending unit 231 illustrated in FIG. 2 and the user-sent information acquisition unit 170 illustrated in FIG. 3. The user-sent information can be acquired by the user-sent information acquisition unit 170 of the server 10 and accumulated in the user-sent information DB 110 illustrated in FIG. 3 whenever a user inputs information via the client 20 (i.e., whenever a user makes a post).

Further, the client 20 may transmit user behavior information to the server 10 along with the user-sent information in the processing shown in step S101. The user behavior information is acquired, for example, by the user behavior information acquisition unit 232 of the client 20 illustrated in FIG. 2, and transmitted to the server 10. The user behavior information transmitted to the server 10 is retained, for example, in the user behavior information DB 150 illustrated in FIG. 3.

Next, the server 10 identifies a user characteristic about an event on the basis of the user-sent information (step S103). The processing shown in step S103 corresponds to the processing executed, for example, by the user characteristic identification unit 180 illustrated in FIG. 3. Additionally, the identification processing of a user characteristic shown in step S103 will be described below in (5-2. Processing Procedure in Identification Processing of User Characteristic) in more detail.

Next, the server 10 distributes presentation information to be presented to the user in relation to the event, on the basis of the identified user characteristic (step S105). The processing shown in step S105 corresponds to the processing executed, for example, by the presentation information distribution unit 190 illustrated in FIG. 3. Additionally, the distribution processing of presentation information shown in step S105 will be described below in (5-3. Processing Procedure in Distribution Processing of Presentation Information) in more detail.

Once the client 20 acquires the distributed presentation information (step S107), the client 20 then displays the presentation information for the user (step S109). The acquisition processing of presentation information shown in step S107 corresponds to the processing executed, for example, by the presentation information acquisition unit 233 illustrated in FIG. 2. The processing shown in step S109 corresponds to the processing executed, for example, by the display control unit 234 illustrated in FIG. 2. In the processing shown in step S109, an advertisement of the merchandise recommendation service, a display screen of the community forming service, or the like can be provided to a user.

The processing procedure of the information processing method according to the present embodiment has been described above with reference to FIG. 8.

### (5-2. Processing Procedure in Identification Processing of User Characteristic)

The identification processing of a user characteristic shown in step S103 of FIG. 8 will be described in more detail. As described above, a user characteristic includes a preference of a user and/or a behavior attribute of a user. The processing procedure in the acquisition processing of user preference information and the processing procedure in the acquisition processing of user behavior attribute information will be described in order.

### (5-2-1. Processing Procedure in Acquisition Processing of User Preference Information)

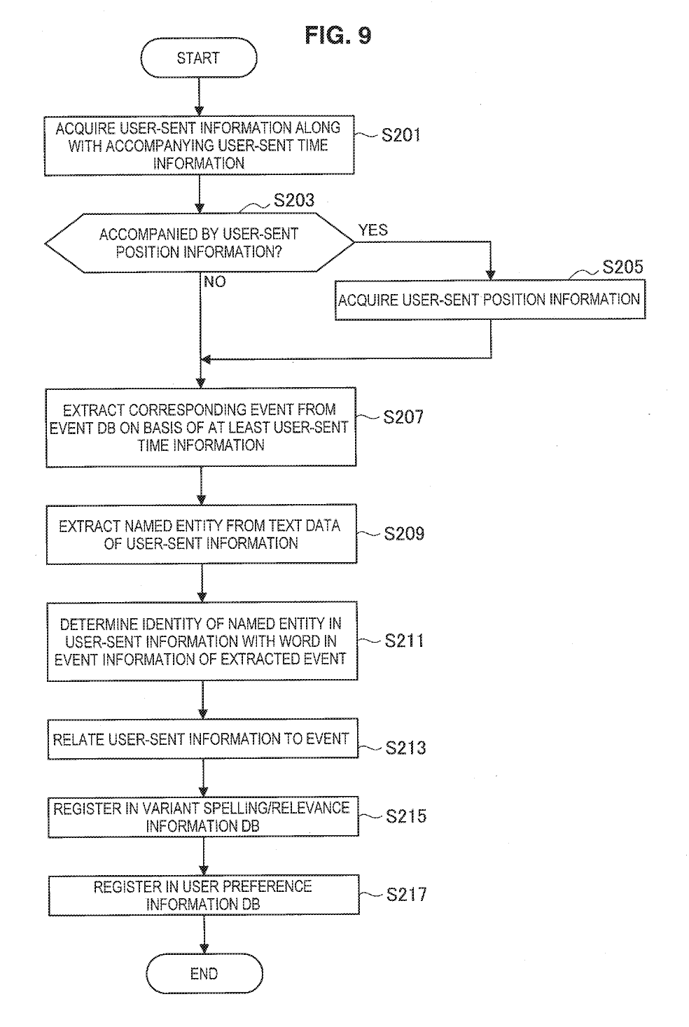

The processing procedure in the acquisition processing of user preference information will be described with reference to FIG. 9. FIG. 9 is a flowchart illustrating an example of a processing procedure in the acquisition processing of user preference information.

FIG. 9 illustrates that user-sent information is first acquired along with the accompanying user-sent time information in the acquisition processing of user preference information according to the present embodiment (step S201). The processing from step S201 to step S207 described below corresponds to the processing executed, for example, by the time/position information comparison unit 181 illustrated in FIG. 3. In the processing shown in step S201, for example, the time/position information comparison unit 181 acquires the user-sent information and the accompanying user-sent time information from the user-sent information DB 110.

Next, it is determined whether the acquired user-sent information is accompanied by user-sent position information (step S203). In a case where it is determined in step S203 that the acquired user-sent information is accompanied by user-sent position information, the processing proceeds to step S205, and the user-sent position information is further acquired from the user-sent information DB 110. In a case where it is determined in step S203 that the acquired user-sent information is accompanied by user-sent position information, the processing proceeds to step S207 with no user-sent position information acquired.

In step S207, on the basis of at least user time sent information, the corresponding event is extracted from the event information DB 120 (see FIG. 3). In the processing shown in step S207, for example, the user-sent time information is compared with the event time information included in the event information in the event information DB 120. For example, in a case where the time of the user-sent time information and the time of the event time information both fall within a predetermined range, the event is extracted as a candidate for the event that the user-sent information targets.

In a case where the user-sent position information is acquired in the processing shown in step S205, an event may be extracted on the basis of the user-sent position information in the processing shown in step S207 in addition to the extraction of an event based on the user-sent time information. In the processing, for example, the user-sent position information is compared with the event position information included in the event information in the event information DB 120. For example, in a case where the distance between the position of the user-sent time information and the position of the event time information both fall within a predetermined range, the event is extracted as a candidate for the event that the user-sent information targets.

Next, a named entity is extracted from the text data of the user-sent information (step S209). The processing from step S209 to step S213 described below corresponds to the processing executed, for example, by the event comparison unit 182 illustrated in FIG. 3. A variety of generally known methods may be used as a specific method for extracting a named entity from text data.

Next, the identity of the named entity extracted from the user-sent information with a word in the event information of the extracted event is determined (step S211). As a technique for determining the relevance between the named entity and the word, a technique is used that carries out an Internet search, for example, with a search word including the combination of the named entity with the word, and determines the relevance between the named entity and the word in accordance with the number of search-resultant web pages. The present embodiment is not, however, limited to this example. A variety of known techniques generally used for the name identification processing may be used as a technique for determining the relevance between the named entity and the word.

Next, on the basis of the determination result in step S211, the user-sent information is related to the event (step S213). In a case where the named entity extracted from the user-sent information has high relevance to the word in the event information, it is determined in the processing shown in step S213 that the user-sent information is information sent for the event, and the user-sent information is related to the event.

Next, the named entity and the word determined in step S211 to have high relevance are associated with each other and registered in the variant spelling/relevance information DB 130 (see FIG. 3) (step S215). This is because a named entity and a word having high relevance are considered as different spellings of the same object. In step S215, the score is calculated that indicates the strength degree of the relevance between the named entity and the word. The score may be related to the named entity and the word, and retained in the user preference information DB 140.

The user of the user-sent information related in step S213 and the event are associated with each other, and registered in the user preference information DB 140 (see FIG. 3) (step S217). This is because the user-sent information and the event being related to each other means that the user-sent information is sent for the event, and the user who sends the user-sent information is therefore considered to be interested in the event. In step S217, the score may be calculated that indicates the strength degree of a preference of the user for the event, and the score may be related to the user ID and the event ID and registered in the user preference information DB 140.

The processing procedure in the acquisition processing of user preference information has been described above with reference to FIG. 9.

### (5-2-2. Processing Procedure in Acquisition Processing of User Behavior Attribute Information)

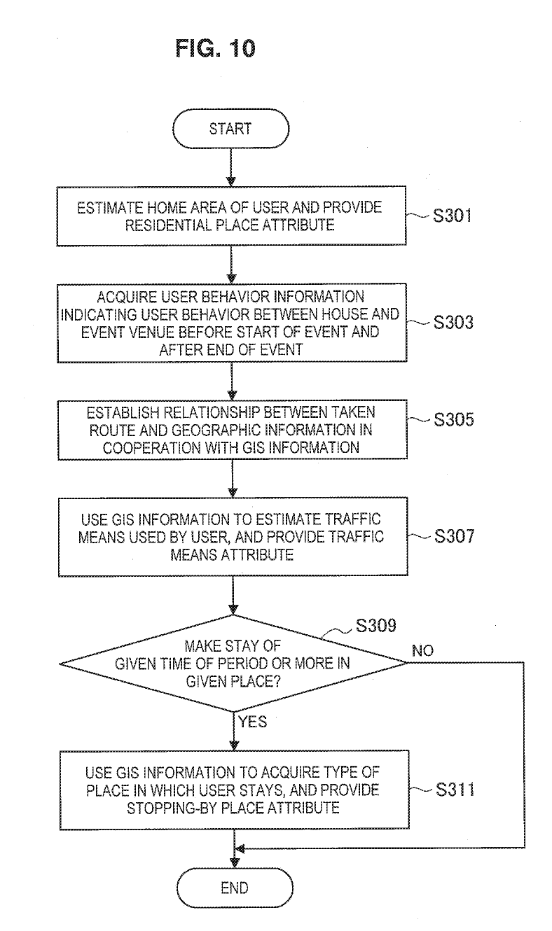

The processing procedure in the acquisition processing of user behavior attribute information will be described with reference to FIG. 10. FIG. 10 is a flowchart illustrating an example of the processing procedure in the acquisition processing of user behavior attribute information. Each processing shown in FIG. 10 corresponds to the processing executed, for example, by the user behavior attribute providing unit 183 illustrated in FIG. 3.

FIG. 10 illustrates that user behavior information is first acquired from the user behavior information DB 150 (see FIG. 3), the home area of a user is estimated on the basis of the user behavior information, and the residential place attribute is provided to the user in the acquisition processing of user behavior attribute information according to the present embodiment (step S301). In the processing shown in step S301, for example, the area in which the user is staying for a given period of time or more in the nighttime is estimated as the home area of the user on the basis of the history of the position information of the user included in the user behavior information. The residential place attribute indicating the residential place area such as “Kanto area” and “Kansai area” is then provided to the user in accordance with the estimated home area.

Next, user behavior information is acquired that indicates a user behavior between the house and an event venue before the start of the event and after the end of the event (step S303). In the processing shown in step S303, for example, on the basis of the user-sent information and the event related to each other in the processing shown in step S213 of FIG. 8, the user behavior information indicating a user behavior of the user who sends the user-sent information between the house of the user and the event venue of the event is acquired from among the user behavior information on the user from the user behavior information DB 150 illustrated in FIG. 3.

Next, the relationship is established between the user behavior information indicating the user behavior information (i.e., a route taken by the user) between the house and the event venue and various types of geographic information in cooperation with GIS information (step S305).

Next, the GIS information is used to compare the route taken by the user with traffic means, thereby estimating a traffic means used by the user to provide a traffic means attribute to the user (step S307). For example, in a case where the route taken by the user overlaps with the route of a train or a bus, it is estimated in the processing shown in step S307 that the user uses the train or the bus. Alternatively, for example, in a case where the route taken by the user deviates from the route of a train or a bus, and the user is considered to be in an automobile on the basis of the moving speed of the user, it is estimated that the user uses a taxi. A traffic means attribute such as “train,” “bus,” or “taxi” is provided to the user in accordance with the estimated transportation means used.

Next, it is determined whether a stay of a given period of time or more is made in a given place on the taken route (step S309). In a case where the stay of a given period of time or more is not made in a given place in step S309, the user is considered to be moving without stopping by any place before the start of the event or after the end of the event. In this case, the series of processing terminates without providing any more behavior attributes.

Conversely, in a case where the stay of a given period of time or more is made in a given place in step S309, the user is considered to stop by some place before the start of the event or after the end of the event. The processing thus proceeds to step S311 in this case. In step S311, the GIS information is used to acquire the type of place (such as a restaurant or a convenience store) to stay, and a stopping-by place of the user is estimated. A stopping-by place attribute such as “restaurant” or “convenience store” is then provided to the user in accordance with the estimated stopping-by place.

The processing procedure in the acquisition processing of user behavior attribute information has been described above with reference to FIG. 10. It has been described that a residential place attribute, a traffic means attribute, and a stopping-by place attribute are provided to a user as behavior attributes in the example illustrated in FIG. 10, but the types of behavior attribute provided to a user are not limited to the examples. Any other behavior attributes may be provided to a user. Although not illustrated in FIG. 10, for example, a workplace attribute indicating the area of the workplace of a user may be provided as a behavior attribute.

### (5-3. Processing Procedure in Distribution Processing of Presentation Information)

The distribution processing of presentation information shown in step S105 of FIG. 8 will be described in more detail. As described above, various types of presentation information may be distributed to the client 20 in accordance with a service provided by the server 10 in the present embodiment. The following describes the processing procedure in the merchandise recommendation service, and the processing procedure in the community forming service in order as examples of the distribution processing of presentation information.

### (5-3-1. Processing Procedure in Merchandise Recommendation Service)

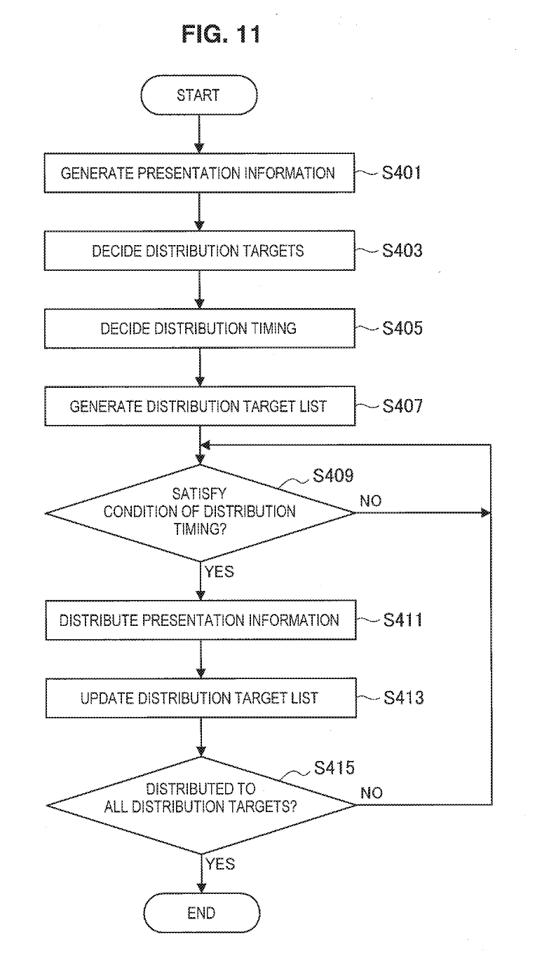

The processing procedure of the distribution processing of presentation information in the merchandise recommendation service will be described with reference to FIG. 11. FIG. 11 is a flowchart illustrating an example of a processing procedure of the distribution processing of presentation information in the merchandise recommendation service. Each processing illustrated in FIG. 11 corresponds to the processing, for example, executed by the presentation information distribution unit 190 illustrated in FIG. 3.

FIG. 11 illustrates that presentation information is first generated in the distribution processing of presentation information in the merchandise recommendation service (step S401). For example, an advertisement of merchandise is distributed as presentation information in the merchandise recommendation service. The layout of the advertisement or information described on the advertisement is preset by the seller of the merchandise, the advertiser of the advertisement, or the like, and stored in a storage device (not illustrated in FIG. 3) included in the server 10. In the processing shown in step S401, for example, information on the advertisement to be distributed is generated on the basis of the preset information.

The presentation information generated in step S401 does not have to come in a single type. For example, in a case where advertisements are concurrently distributed to a single user, some types of presentation information can be generated that correspond to these advertisements in number.

Next, distribution targets are decided to whom the presentation information is distributed (step S403). In the present embodiment, for example, the seller of the merchandise, the advertiser of the advertisement, or the like presets a condition of a target to whom the advertisement is distributed, and the condition is stored in the storage device (not illustrated in FIG. 3) included in the server 10. In the processing shown in step S403, distribution targets are decided on the basis of the preset information.

The condition of distribution targets may comply with the user preference information stored in the user preference information DB 140 illustrated in FIG. 3. For example, in a case where the presentation information generated in step S401 is an advertisement of an event of classical music, a condition or the like of limiting distribution targets to users who are interested in classical music can be set on the basis of the user preference information. Further, the condition of distribution targets may comply with the user behavior attribute information stored in the user behavior attribute information DB 160 illustrated in FIG. 3. For example, in a case where the presentation information generated in step S401 is an advertisement or coupon of a restaurant around an event venue, the condition of limiting distribution targets to users having the behavior attribute of stopping by the restaurant after the end of the event can be set on the basis of the user behavior attribute information. For example, in a case where the presentation information generated in step S401 is an advertisement of a traffic means such as Shinkansen or an airplane for long-distance travel, the condition of limiting distribution targets to users each having a relatively long distance from event venue to the residential place area can be set on the basis of the user behavior attribute information.

The condition of distribution targets is not, however, limited to ones that comply with user preference information or user behavior attribute information. Items such as age or sex that can be set in a general advertisement distribution system may also be set as a condition of distribution targets. The condition of distribution targets may also be set by using an existing prediction engine on the basis of user preference information and/or user behavior attribute information to predict users who are interested in the presentation information (such as an advertisement of merchandise).

Next, distribution timing of the presentation information is decided (step S405). In the present embodiment, for example, the seller of the merchandise, the advertiser of the advertisement, or the like presets a condition of timing at which the advertisement is distributed, and the condition is stored in the storage device (not illustrated in FIG. 3) included in the server 10. In the processing shown in step S405, distribution timing is decided on the basis of the preset information.

The condition of distribution timing may comply with the user behavior attribute information stored in the user behavior attribute information DB 160 illustrated in FIG. 3. For example, the timing immediately after the end of an event can be set as distribution timing for a user having the behavior attribute of stopping by a restaurant after the end of the event. For example, the timing at which a user having the behavior attribute of stopping by a convenience store around the house after the end of an event is predicted to arrive at the house can be set as distribution timing for the user. The timing at which the user arrives around the house can be predicted, for example, on the basis of the event finish time or the traffic means attribute of the user.

Next, a distribution target list is generated on the basis of the distribution targets decided in step S403 and the distribution timing decided in step S405 (step S407). The distribution target list has distribution targets, presentation information to be distributed, and the distribution timing of the presentation information therein in association with each other.

Presentation information will be distributed on the basis of the distribution target list. First, it is determined on the basis of the distribution target list whether each distribution target satisfies the condition of distribution timing (step S409). In a case where no distribution target satisfies the condition of distribution timing, the processing stands by with no presentation information distributed. In a case where there is a distribution target who satisfies the condition of distribution timing, presentation information is distributed to the distribution target (step S411).

Once the presentation information is distributed, the distribution target to whom the presentation information is distributed is deleted from the distribution target list, and the distribution target list is updated (step S413). It is then determined whether the presentation information is distributed to all the distribution targets in the distribution target list (step S415). In a case where the presentation information is not distributed to all the distribution targets, the processing returns to step S409 and the following processing is repeatedly executed. In a case where the presentation information is distributed to all the distribution targets, the series of distribution processing of presentation information terminates.

The processing procedure of the distribution processing of presentation information in the merchandise recommendation service has been described above with reference to FIG. 11.

### (5-3-2. Processing Procedure in Community Forming Service)

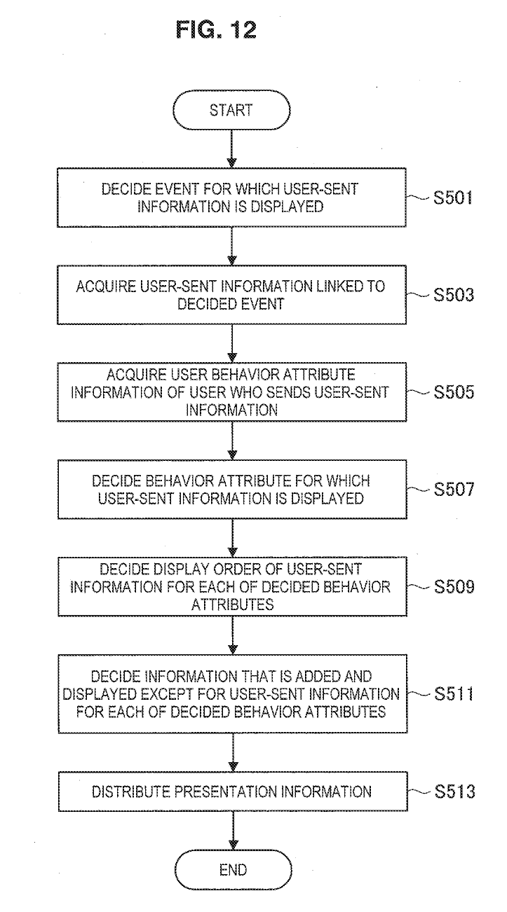

The processing procedure of the distribution processing of presentation information in the community forming service will be described with reference to FIG. 12. FIG. 12 is a flowchart illustrating an example of a processing procedure of the distribution processing of presentation information in a community forming service. Each processing illustrated in FIG. 12 corresponds to the processing, for example, executed by the presentation information distribution unit 190 illustrated in FIG. 3.

FIG. 12 illustrates that an event is first decided for which user-sent information is displayed on a display screen in the distribution processing of presentation information in the community forming service (step S501). Information is distributed for generating a display screen for grouping and displaying user-sent information (such as posts) of users for a certain event for each of the behavior attributes of the users as presentation information in the community forming service. The processing shown in step S501 corresponds to the processing of deciding an event for which user-sent information is displayed on the display screen. An event for which the user-sent information is displayed on the display screen is preset, for example, by a user, the designer of the system 1, or the like, and stored in the storage device (not illustrated in FIG. 3) included in the server 10. Alternatively, information that chooses an event for which the user-sent information is displayed may be input as appropriate, for example, through an operation made by a user via the input unit 210 of the client 20 illustrated in FIG. 2, and transmitted to the server 10. In the processing shown in step S501, an event for which the user-sent information is displayed on the display screen is decided on the basis of the preset information or the information input via the input unit 210.

Next, the user-sent information linked to the decided event is acquired (step S503). For example, in the processing shown in step S503, the user-sent information related to the event decided in step S501 is acquired from the user-sent information DB 110 illustrated in FIG. 3 on the basis of the user-sent information and event related in the processing shown in step S213 of FIG. 8.

Next, the user behavior attribute information of the user who sends the acquired user-sent information is acquired (step S505). In the processing shown in step S505, the user behavior attribute information associated with the same user ID as the user ID of the user-sent information acquired in step S503 is acquired, for example, from the user behavior attribute information DB 160 illustrated in FIG. 3.

Next, a behavior attribute is decided for which the user-sent information is displayed on the display screen (step S507). A behavior attribute for which the user-sent information is displayed on the display screen is preset, for example, by a user, the designer of the system 1, or the like, and stored in the storage device (not illustrated in FIG. 3) included in the server 10. Alternatively, information that chooses a behavior attribute for which the user-sent information is displayed may be input as appropriate, for example, through an operation made by a user via the input unit 210 of the client 20 illustrated in FIG. 2, and transmitted to the server 10. Alternatively, a behavior attribute for which the user-sent information is displayed may be automatically decided, for example, by selecting a behavior attribute similar to a behavior attribute of a user who is a distribution target of presentation information with a known recommendation technique or the like. In the processing shown in step S507, a behavior attribute for which the user-sent information is displayed on the display screen is decided on the basis of the presentation information, the information input via the input unit 210, or the information that is automatically decided.

Next, the display order of the user-sent information is decided for each of the decided behavior attributes (step S509). The display order of the user-sent information may be the sent-time order of the user-sent information or the order from the user-sent information considered to have the highest relevance to the behavior attribute using the document classification technology of natural language processing. For example, a user, the designer of the system 1, or the like presets which of the display orders is adopted, and the adopted display order is stored in the storage device (not illustrated in FIG. 3) included in the server 10. Alternatively, the display order of the user-sent information may be freely chosen, for example, through an operation made by a user via the input unit 210 of the client 20 illustrated in FIG. 2. In the processing shown in step S509, the display order of the user-sent information is decided for each behavior attribute in accordance with the order preset and stored in the storage device, or the order input by a user via the input unit 210.

Next, information to be added and displayed except for the user-sent information is decided for each of the decided behavior attributes (step S511). The information to be added and displayed (which will also be referred to as additional information) is, for example, an advertisement of merchandise or the like which is similar to information distributed in the merchandise recommendation service. The additional information may be, for example, an advertisement of merchandise relating to the event decided in step S501. Alternatively, the additional information may be, for example, an advertisement of merchandise considered necessary for a user having the behavior attribute decided in step S505. For example, in a case where the stopping-by place attribute of stopping by a restaurant is selected in step S505, an advertisement or coupon of a restaurant around an event venue can be favorably selected as additional information. Alternatively, for example, in a case where the residential place attribute indicating that an event venue is relatively distant from the house is selected in step S505, an advertisement of a traffic means such as an airplane or Shinkansen for long-distant travel can be favorably selected as additional information.

Finally, presentation information (i.e., information necessary for generating a display screen) is generated on the basis of the variety of items decided in step S501 to step S511, and the presentation information is distributed (step S513). In the processing shown in step S513, the user-sent information acquired in step S503 for the event decided in step S501 is arranged for each of the behavior attributes decided in step S507 in the display order decided in step S509, and information for configuring the display screen to which the additional information decided in step S511 is added is generated as presentation information and distributed to the client 20 illustrated in FIG. 2. The display control unit 234 of the client 20 causes the display unit 220 on the basis of the presentation information to display the display screen on which the user-sent information of users for a certain event is grouped and displayed for each of the behavior attributes of the users.

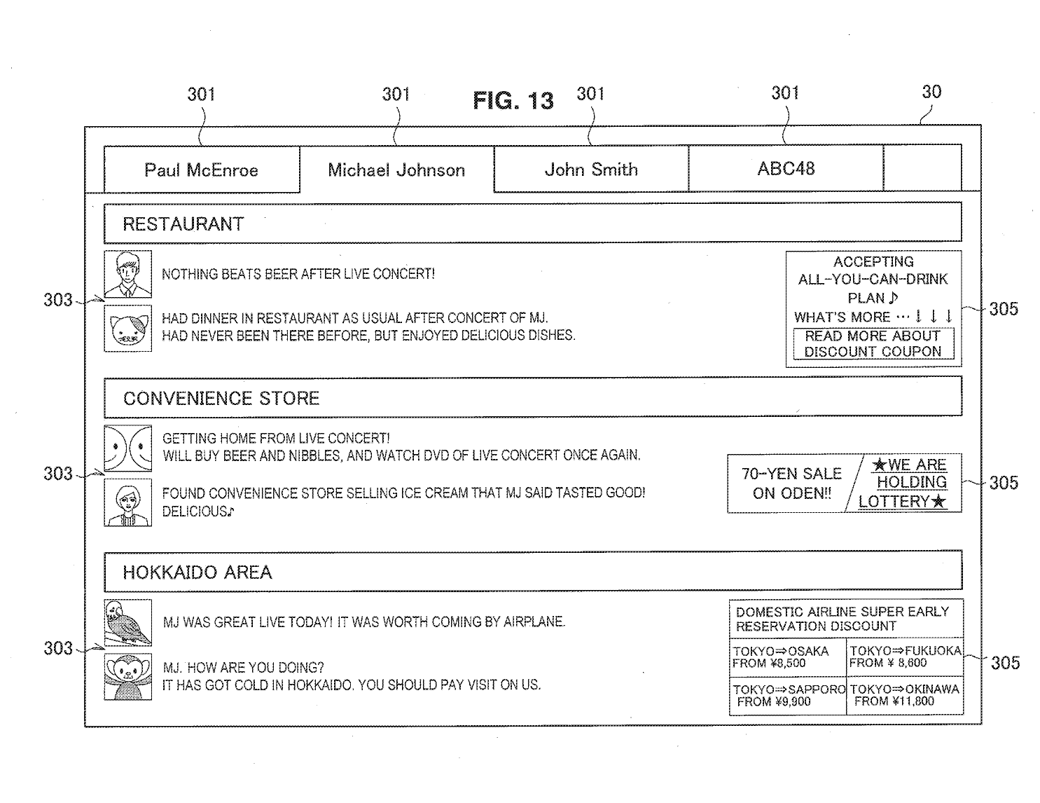

FIG. 13 illustrates an example of a display screen displayed on the display unit 220 of the client 20 through the series of processing illustrated in FIG. 12. FIG. 13 is a diagram illustrating an example of a display screen provided to a user in the community forming service.

FIG. 13 illustrates that a display screen 30 includes tabs 301 for selecting an event for which user-sent information is displayed, sections 303 in which user-sent information is displayed for each behavior attribute, and sections 305 in which additional information is displayed. A user can select any of the tabs 301, for example, through an operation made via the input unit 210 illustrated in FIG. 2, and choose an event for which user-sent information is displayed. In the example illustrated in FIG. 13, “Michael Johnson” is selected as the tab 301, and an event relating to “Michael Johnson” is selected.

Posts of each user are displayed in the section 303 along with the icon representing each user. In the example illustrated in FIG. 13, posts made by a user having the stopping-by place attribute “restaurant” as a behavior attribute, posts made by a user having the stopping-by place attribute “convenience store” as a behavior attribute, and posts made by a user having the residential place attribute “Hokkaido area” as a behavior attribute are displayed.

Advertisements, coupons, and the like of merchandise are displayed in the sections 305 as additional information. In the example illustrated in FIG. 13, coupons of restaurants and convenience stores are displayed in the sections 303 in which posts made by users having the stopping-by place attribute “restaurant” or “convenience store” as a behavior attribute are displayed. Further, advertisements of airplane tickets are displayed in the section 303 in which posts made by users having the residential place attribute “Hokkaido area” as a behavior attribute are displayed.

Various types of display (posts and additional information) of the display screen 30 or the like may be updated as needed through the series of processing illustrated in FIG. 8, for example, whenever user-sent information is newly sent, or at predetermined intervals. This updates and presents, for a user as needed, posts made by other users who have similar preferences or similar behavior attributes to those of the user, facilitating the users to communicate with each other.

The processing procedure of the distribution processing of presentation information in the community forming service has been described above with reference to FIG. 12.

### (6. Modification)

The description has been made in the above-described embodiment using, as an example, the case where content handled by the system 1 is an event. The present embodiment is not, however, limited to the example. The system 1 may also handle other content. Here, the case where content handled by the system 1 is video content (what is called a TV program) broadcast from a broadcasting station will be described as a modification of the present embodiment.

Even in a case where content handled by the system 1 is video content, the functional configurations of the system 1, and the server 10 and the client 20 included in the system 1 are similar to those of the above-described embodiment. Accordingly, what is similar to those of the above-described embodiment will not be described in detail in the present modification. Differences from the above-described embodiment will be chiefly described.

User-sent information is also transmitted from the client 20 to the server 10 in the present modification. In addition, user behavior information may be further transmitted from the client 20 to the server 10. The server 10 performs the processing of relating the user-sent information to video content, namely, identifying video content that the user-sent information targets.

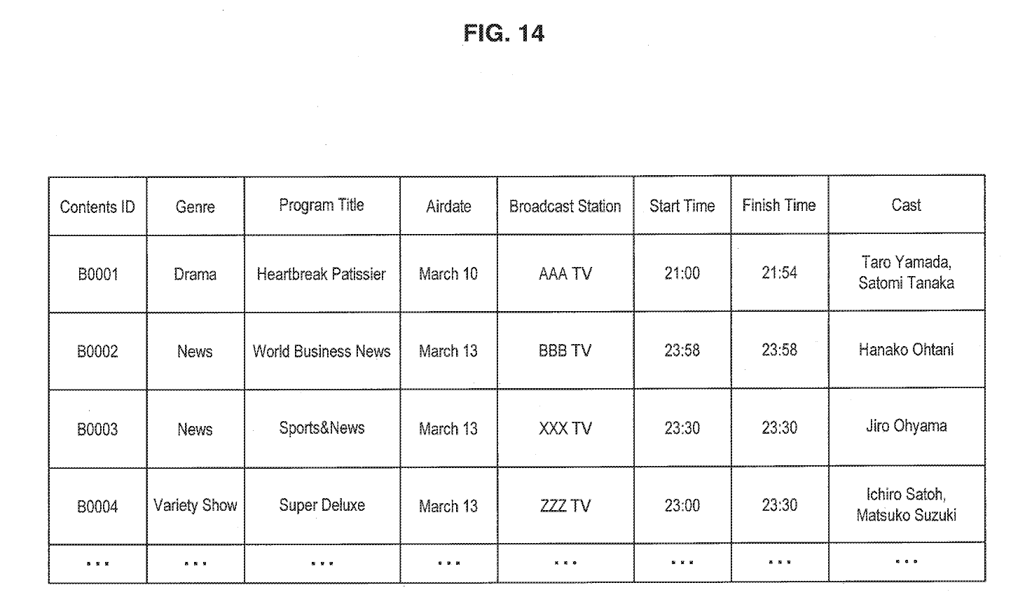

Instead of the event information DB 120 illustrated in FIG. 3, there is provided a video content information DB that stores various types of information (video content information) on video content in the present modification. FIG. 14 illustrates an example of video content information stored in the video content information DB. FIG. 14 is a diagram illustrating an example of video content information stored in the video content information DB.

As illustrated in FIG. 14, the video content information DB retains, as video content information, the content IDs for identifying video content, the genres of video content, video content names (program names), the broadcasting dates of video content, the broadcasting stations of video content, the broadcasting start time of video content, the broadcasting finish time of video content, and the cast of video content in association with each other. The broadcasting start time of video content and the broadcasting finish time of video content correspond to the event time information in the event information DB 120 in the above-described embodiment, and are the time information (video content time information) accompanying the video content. Additionally, a variety of existing DBs such as an electronic program guide (EPG) generally provided for digital broadcasting can be used as the video content information DB.

In the present modification, the time/position information comparison unit 181 of the user characteristic identification unit 180 can extract a candidate for the video content corresponding to the user-sent information from among the video content stored in the video content information DB by comparing the user-sent time information accompanying the user-sent information with the video content time information in the video content information DB.

In a case where content is video content like the present modification, video content information is frequently accompanied by no position information unlike the case of events. This is because video content is not distributed only in a predetermined place unlike events. In the following description of the present modification, the case will be therefore described where the extraction processing of a candidate for video content which is based on position information is not performed.

The event comparison unit 182 extracts a named entity from the text data of the user-sent information, and determines the identity of the extracted named entity with a word included in the video content information of the video content extracted by the time/position information comparison unit 181, thereby relating the user-sent information to the video content. For example, the event comparison unit 182 uses the combination of a named entity included in the user-sent information and a word included in the video content information as a search word to carry out an Internet search. For example, in a case where the posts illustrated in FIG. 4 are made and the video content information DB illustrated in FIG. 14 is constructed, the following search words 7 to 10 can be created as search words.

### Search Word 7: “WBN & Hanako Ohtani”

### Search Word 8: “World Business News & Ohtani”

### Search Word 9: “WBN & Jiro Ohyama”

### Search Word 10: “Sports&News & Ohtani”

It is assumed as a result of the Internet search that the number of web pages resulting from the search of the search words 7 and 8 exceeds a predetermined threshold, and the number of web pages resulting from the search of search words 9 and 10 is less than or equal to the predetermined threshold. In that case, the event comparison unit 182 determines that the user-sent information that is user-sent information from which the named entity “WBN” is extracted and that is sent by the user having the user ID U0001 as illustrated in FIG. 4 has high relevance to the video content that is video content including the word “World Business News” and having the content ID B0002 as illustrated in FIG. 14, and relates the user-sent information to the video content.

The event comparison unit 182 then then stores the user of the related user-sent information and the video content in the user preference information DB 140 in association with each other as user preference information indicating an interest of the user. For example, as described above, it is assumed that the event comparison unit 182 determines that user-sent information sent by the user having the user ID U0001 illustrated in FIG. 4 has high relevance to the video content having the content ID B0002 illustrated in FIG. 14, and relates the user-sent information to the video content. In this case, as illustrated in FIG. 6, the user ID: U0001 and the content ID: B0002 is retained in the user preference information DB 140 in association with each other on the basis of the related user-sent information and video content. The event comparison unit 182 also computes the score indicating the strength degree of a preference of the user for the event, relates the score to the user ID and the event ID, and retains the score in the user preference information DB 140.

Further, as described in the above-described embodiment, it is possible even to identify the concept represented by an extracted named entity in the named entity extraction processing. The event comparison unit 182 therefore determines that “WBN” extracted from the user-sent information and “World Business News” included in the video content information, which are considered to have high relevance on the basis of the result of the Internet search, are variant spellings of the same program name, and stores “WBN” and “World Business News” in the variant spelling/relevance information DB 130 in association with each other as variant spelling/relevance information. The event comparison unit 182 also computes the score indicating the strength degree of the relevance between these words, relates the score to “WBN” and “World Business News,” and retains the score in the variant spelling/relevance information DB 150. Similarly, the event comparison unit 182 determines that “Ohtani” extracted from the user-sent information and “Hanako Ohtani” included in the video content information are variant spellings of the same person's name, and stores “Ohtani” and “Hanako Ohtani” in the variant spelling/relevance information DB 130 in association with each other. In addition, the event comparison unit 182 computes the score between these words, and also stores the score in the variant spelling/relevance information DB 130 (see FIG. 7).

The following processing is similar to that of the above-described embodiment. The user behavior attribute providing unit 183 provides a user behavior attribute to each user on the basis of the user behavior information in the user behavior information DB 150, and stores a result in the user behavior attribute information DB 160. The presentation information distribution unit 190 decides a user to whom an advertisement of the merchandise recommendation service is distributed and the timing of the distribution, on the basis of the user preference information in the user preference information DB 140 and/or the user behavior attribute information in the user behavior attribute information DB 160, and distributes the advertisement to the client 20. Further, the presentation information distribution unit 190 decides information for generating a display screen of the community forming service and distributes the information to a user, on the basis of the user preference information in the user preference information DB 140 and/or the user behavior attribute information in the user behavior attribute information DB 160, and distributes the advertisement to the client 20.

The modification has been described above in which content handled by the system 1 is video content distributed from a broadcasting station.

### (7. Hardware Configuration)

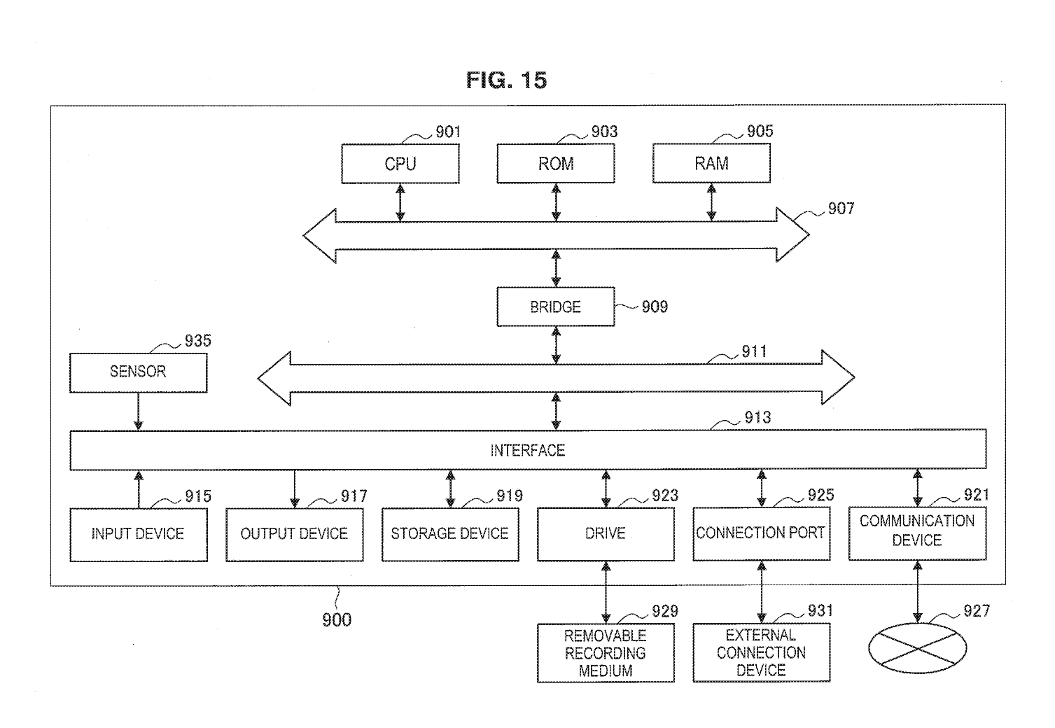

Next, a hardware configuration of an information processing device according to the present embodiment will be described with reference to FIG. 15. FIG. 15 is a block diagram illustrating an example of the hardware configuration of an information processing device according to the present embodiment. The information processing device 900 illustrated in FIG. 15 can implement, for example, the client 20 and the server 10 illustrated in FIGS. 2 and 3, respectively.

The information processing device 900 includes a CPU 901, a read only memory (ROM) 903, and a random access memory (RAM) 905. In addition, the information processing device 900 may include a host bus 907, a bridge 909, an external bus 911, an interface 913, an input device 915, an output device 917, a storage device 919, a communication device 921, a drive 923, a connection port 925, and a sensor 935. The information processing device 900 may include a processing circuit such as a DSP or an ASIC instead of or in combination with the CPU 901.

The CPU 901 functions as an operation processor and a controller, and controls all or some operations in the information processing device 900 in accordance with a variety of programs recorded on the ROM 903, the RAM 905, the storage device 919, or a removable recording medium 929. The ROM 902 stores a program, an operation parameter, or the like that is used by the CPU 901. The RAM 905 primarily stores a program used for the execution of the CPU 901, a parameter at the time of the execution, and the like. The CPU 901 can be included, for example, in the control unit 230 illustrated in FIG. 2, and the user-sent information acquisition unit 170, the user characteristic identification unit 180, and the presentation information distribution unit 190 illustrated in FIG. 3.

The CPU 901, the ROM 903, and the RAM 905 are connected to each other by the host bus 907 including an internal bus such as a CPU bus. In addition, the host bus 907 is connected to the external bus 911 such as a peripheral component interconnect/interface (PCI) bus via the bridge 909.

The host bus 907 is connected to the external bus 911 such as a peripheral component interconnect/interface (PCI) bus via the bridge 909.

The input device 915 includes a device which is operated by a user, such as a mouse, a keyboard, a touch panel, a button, a switch, and a lever. In addition, the input device 915 may be, for example, a remote control device (so-called remote controller) using infrared light or other radio waves, or may be an external connection device 931 such as a mobile phone and a PDA operable in response to the operation of the information processing device 900. Further, the input device 915 includes, for example, an input control circuit or the like that generates an input signal on the basis of information input by a user using the above-described operation means, and outputs the input signal to the CPU 901. A user of the information processing device 900 can input a variety of data to the information processing device 900 and require the information processing device 900 to perform a processing operation by operating this input device 915. The input device 915 can be included, for example, in the input unit 210 illustrated in FIG. 2. A user inputs information such as posts on different kinds of content via the input device 915 in the present embodiment.

The output device 917 includes a device capable of visually or aurally notifying the user of acquired information. Such a device includes a display device such as a CRT display device, a liquid crystal display device, a plasma display device, an EL display device and a lamp, an audio output device such as a speaker and a headphone, a printer device, or the like. The output device 917 outputs, for example, results obtained from various types of processing performed by the information processing device 900. Specifically, the display device visually displays results obtained from various types of processing performed by the information processing device 900 in a variety of forms such as text, an image, a table, and a graph. Meanwhile, the audio output device converts audio signals including reproduced audio data, acoustic data, or the like into analog signals, and aurally outputs the analog signals. The above-described display device can be included, for example, in the display unit 220 illustrated in FIG. 2. The above-described display device displays advertisements of the merchandise recommendation service, display screens of the community forming service, or the like in the present embodiment.

The storage device 919 is a device for data storage which is configured as an example of a storage unit of the information processing device 900. The storage device 919 includes, for example, a magnetic storage device such as a HDD, a semiconductor storage device, an optical storage device, a magneto-optical storage device, or the like. The storage device 919 stores a program to be executed by the CPU 901, various types of data, various types of data acquired from the outside, and the like. The storage device 919 can be included, for example, in the user-sent information DB 110, the event information DB 120, the variant spelling/relevance information DB 130, the user preference information DB 140, the user behavior information DB 150, and the user behavior attribute information DB 160 illustrated in FIG. 3. The storage device 919 retains various types of information included in each of the above-described DBs in the present embodiment. Further, the storage device 919 may store information necessary for generating an advertisement of merchandise, information on the setting of a distribution target and distribution timing of an advertisement, information on various types of setting for generating a display screen of the community forming service, or the like.

The communication device 921 is, for example, a communication interface including a communication device or the like for a connection to a communication network (network) 927. The communication device 921 may be, for example, a communication card for a wired or wireless local area network (LAN), Bluetooth (registered trademark), a wireless USB (WUSB), or the like. In addition, the communication device 921 may be a router for optical communication, a router for an asymmetric digital subscriber line (ADSL), a modem for various kinds of communication, or the like. This communication device 921 can transmit and receive signals or the like, for example, to and from the Internet or other communication devices in compliance with a predetermined protocol such as TCP/IP. Further, the network 927 connected to the communication device 921 includes a network or the like that is connected in a wired or wireless manner, and may be, for example, the Internet, a home LAN, infrared communication, radio wave communication, satellite communication, or the like. The communication between the server 10 and the client 20 illustrated in FIG. 1 may be executed by the communication device 921 via the network 927 in the present embodiment.

The drive 923 is a reader/writer for a recording medium, and is built in or externally attached to the information processing device 900. The drive 923 reads out information recorded on a removable recording medium 929 such as mounted magnetic disks, optical discs, magneto-optical disks and semiconductor memory, and outputs the read-out information to the RAM 905. Further, the drive 923 can also write information into the attached removable recording medium 929 such as a magnetic disk, an optical disc, a magneto-optical disk, or a semiconductor memory. The removable recording medium 929 is, for example, a DVD medium, an HD-DVD medium, a Blu-ray (registered trademark) medium, or the like. Further, the removable recording medium 929 may also be CompactFlash (registered trademark) (CF), a flash memory, a secure digital (SD) memory card, or the like. Further, the removable recording medium 929 may also be, for example, an integrated circuit (IC) card, an electronic device, or the like having a contactless IC chip. Various types of information processed by the control unit 230, the user-sent information acquisition unit 170, the user characteristic identification unit 180, and the presentation information distribution unit 190 illustrated in FIGS. 2 and 3, or various types of information stored in each of the various DBs illustrated in FIG. 3 may be read out from the removable recording medium 929 or written into the removable recording medium 929 by the drive 923 in the present embodiment.

The connection port 925 is a port used to directly connect a device to the information processing device 900. Examples of the connection port 925 include a universal serial bus (USB) port, an IEEE1394 port, and a small computer system interface (SCSI) port. Another example of the connection port 925 includes an RS-232C port, an optical audio terminal, a High-Definition Multimedia Interface (HDMI) (registered trademark) port, and the like. Connecting the external connection device 931 to this connection port 925 allows the information processing device 900 to directly acquire various types of data from the external connection device 931 or to provide various types of data to the external connection device 931. Various types of information processed by the control unit 230, the user-sent information acquisition unit 170, the user characteristic identification unit 180, and the presentation information distribution unit 190 illustrated in FIGS. 2 and 3, or various types of information stored in each of the various DBs illustrated in FIG. 3 may be acquired from the external connection device 931 or output to the external connection device 931 via the connection port 925 in the present embodiment.

The sensor 935 includes various sensors such as an acceleration sensor, a gyro sensor, a geomagnetic sensor, an optical sensor, a sound sensor, a distance measurement sensor, and a force sensor. The sensor 935 acquires information on the state of the information processing device 900 itself, such as the posture and moving speed of the information processing device 900, and information on the environment around the information processing device 900, such as the brightness and noise around the information processing device 900. Further, the sensor 935 may include a GPS sensor that receives GPS signals to measure the latitude, longitude, and altitude of the device. The sensor 935 can be included, for example, in the input unit 210 illustrated in FIG. 2. Position information acquired by the sensor 935 can be used as the user-sent position information accompanying user-sent information in the present embodiment. Further, user behavior information can be acquired on the basis of various types of information acquired by the sensor 935.

The example of a hardware configuration that can implement the functions of the information processing device 900 according to the present embodiment has been described above. Each of the above-described components may be configured with a general-purpose member, and may also be configured with hardware specialized in the function of each component. Thus, the hardware configuration used can be modified as appropriate in accordance with the technological level at the time of the implementation of the present embodiment.

It is possible to create a computer program for implementing each function of the information processing device 900 according to the above-described embodiment, and to implement the computer program in a PC or the like. There can also be provided a computer-readable recording medium having the computer program stored therein. Examples of the recording medium include a magnetic disk, an optical disc, a magneto-optical disk, and a flash memory. The computer program may also be distributed via a network, for example, using no recording medium.

### (8. Supplemental Information)

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing device including:

a user characteristic identification unit configured to identify a characteristic of a user about content by relating user-sent information sent by the user for the content to the content; and

a presentation information distribution unit configured to distribute presentation information to be presented to the user in relation to the content on the basis of characteristic information indicating the identified characteristic of the user.

(2)

The information processing device according to (1), wherein

the characteristic information includes at least one of user preference information indicating an interest of the user in the content, and user behavior attribute information indicating a behavior attribute of the user for the content.

(3)

The information processing device according to (2), wherein

the presentation information distribution unit distributes, to the user, information on merchandise in which the user is predicted to be interested on the basis of at least one of the user preference information and the user behavior attribute information.

(4)

The information processing device according to (3), wherein

the presentation information distribution unit decides the user to whom the information on the merchandise is distributed, and timing at which the information on the merchandise is distributed to the user, on the basis of the user behavior attribute information.

(5)

The information processing device according to (3) or (4), wherein

the presentation information distribution unit distributes, to the user, information on merchandise depending on a residential region of the user on the basis of the user behavior attribute information.

(6)

The information processing device according to any one of (2) to (5), wherein

the presentation information distribution unit distributes, to the user, information for generating a display screen that groups and displays the user-sent information for each of users having similar behavior attributes, on the basis of the user behavior attribute information.

(7)

The information processing device according to any one of (1) to (6), wherein

the user characteristic identification unit relates the user-sent information to the content at least on the basis of user-sent time information accompanying the user-sent information.

(8)

The information processing device according to (7), wherein

the user characteristic identification unit extracts the content that the user-sent information targets, by comparing the user-sent time information accompanying the user-sent information with content time information accompanying the content, and relates the extracted content to the user-sent information.

(9)

The information processing device according to (8), wherein

the user characteristic identification unit further extracts the content that the user-sent information targets, by comparing the user-sent position information accompanying the user-sent information with content position information accompanying the content, and relates the extracted content to the user-sent information.

(10)

The information processing device according to (8) or (9), wherein

the user characteristic identification unit relates the user-sent information to the content by determining identity of a named entity in text data of the user-sent information with a word in text data included in content information on the extracted content.

(11)

The information processing device according to any one of (1) to (10), wherein

the content is an event held in a predetermined place at a predetermined date and time.

(12)

The information processing device according to any one of (1) to (10), wherein

the content is video content broadcast at a predetermined date and time.

(13)

An information processing method including, by a processor:

identifying a characteristic of a user about content by relating user-sent information sent by the user for the content to the content; and

distributing presentation information to be presented to the user in relation to the content on the basis of characteristic information indicating the identified characteristic of the user.

(14)

A program for a processor of a computer to execute:

a function of identifying a characteristic of a user about content by relating user-sent information sent by the user for the content to the content; and

a function of distributing presentation information to be presented to the user in relation to the content on the basis of characteristic information indicating the identified characteristic of the user.

### REFERENCE SIGNS LIST

1 system
10 server
20 client
110 user-sent information DB
120 event information DB
130 variant spelling/relevance information DB
140 user preference information DB
150 user behavior information DB
160 user behavior attribute information DB
170 user-sent information acquisition unit
180 user characteristic identification unit
181 time/position information comparison unit
182 event comparison unit
183 user behavior attribute providing unit
190 presentation information distribution unit
210 input unit
220 display unit
230 control unit
231 user input information sending unit
232 user behavior information acquisition unit
233 presentation information acquisition unit
234 display control unit

1. An information processing device comprising:
a user characteristic identification unit configured to identify a characteristic of a user about content by relating user-sent information sent by the user for the content to the content; and
a presentation information distribution unit configured to distribute presentation information to be presented to the user in relation to the content on the basis of characteristic information indicating the identified characteristic of the user.

2. The information processing device according to claim 1, wherein
the characteristic information includes at least one of user preference information indicating an interest of the user in the content, and user behavior attribute information indicating a behavior attribute of the user for the content.

3. The information processing device according to claim 2, wherein
the presentation information distribution unit distributes, to the user, information on merchandise in which the user is predicted to be interested on the basis of at least one of the user preference information and the user behavior attribute information.

4. The information processing device according to claim 3, wherein
the presentation information distribution unit decides the user to whom the information on the merchandise is distributed, and timing at which the information on the merchandise is distributed to the user, on the basis of the user behavior attribute information.

5. The information processing device according to claim 3, wherein
the presentation information distribution unit distributes, to the user, information on merchandise depending on a residential region of the user on the basis of the user behavior attribute information.

6. The information processing device according to claim 2, wherein
the presentation information distribution unit distributes, to the user, information for generating a display screen that groups and displays the user-sent information for each of users having similar behavior attributes, on the basis of the user behavior attribute information.

7. The information processing device according to claim 1, wherein
the user characteristic identification unit relates the user-sent information to the content at least on the basis of user-sent time information accompanying the user-sent information.

8. The information processing device according to claim 7, wherein
the user characteristic identification unit extracts the content that the user-sent information targets, by comparing the user-sent time information accompanying the user-sent information with content time information accompanying the content, and relates the extracted content to the user-sent information.

9. The information processing device according to claim 8, wherein
the user characteristic identification unit further extracts the content that the user-sent information targets, by comparing the user-sent position information accompanying the user-sent information with content position information accompanying the content, and relates the extracted content to the user-sent information.

10. The information processing device according to claim 8, wherein
the user characteristic identification unit relates the user-sent information to the content by determining identity of a named entity in text data of the user-sent information with a word in text data included in content information on the extracted content.

11. The information processing device according to claim 1, wherein
the content is an event held in a predetermined place at a predetermined date and time.

12. The information processing device according to claim 1, wherein
the content is video content broadcast at a predetermined date and time.

13. An information processing method comprising, by a processor:
identifying a characteristic of a user about content by relating user-sent information sent by the user for the content to the content; and
distributing presentation information to be presented to the user in relation to the content on the basis of characteristic information indicating the identified characteristic of the user.

14. A program for a processor of a computer to execute:
a function of identifying a characteristic of a user about content by relating user-sent information sent by the user for the content to the content; and
a function of distributing presentation information to be presented to the user in relation to the content on the basis of characteristic information indicating the identified characteristic of the user.
